(19) United States
(12) Patent Application Publication
(10) Pub. No.: US 2017/0103409 A1
(43) Pub. Date: Apr. 13, 2017

(54) SYSTEM AND METHOD FOR MANAGING AND PRESENTING SUPPLY-CHAIN DATA

(71) Applicant: 10-Forward, LLC, Honeoye Falls, NY (US)

(72) Inventor: Stephen M. Strasser, Honeoye Falls, NY (US)

(73) Assignee: 10-Forward, LLC, Honeoye Falls, NY (US)

(21) Appl. No.: 15/384,464

(22) Filed: Dec. 20, 2016

Related U.S. Application Data
(63) Continuation-in-part of application No. 14/881,240, filed on Oct. 13, 2015.
Application No. 14/881,240 is a continuation of application No. 12/574,050, filed on Oct. 6, 2009, now abandoned.
Application No. 12/574,050 is a continuation-in-part of application No. 10/860,986, filed on Jun. 4, 2004, now abandoned.
(60) Provisional application No. 60/475,587, filed on Jun. 4, 2003.

(51) Int. Cl. G06Q 30/02; G06Q 10/08; G06Q 30/06

(52) U.S. Cl. CPC G06Q 30/0227; G06Q 30/0641; G06Q 10/087

(57) ABSTRACT

A system, method and computer program product for managing and/or presenting supply-chain data is presented. In one embodiment, the system includes a database for storing the supply-chain data and a server. The server is configured to present multiple role-specific user interfaces to multiple users. The multiple role-specific user interfaces include a distributor user interface, a customer user interface, and a vendor user interface presenting corresponding views. One or more distributor views include product information, pricing information, vendor information, and customer information. One or more customer views include the product information, the pricing information, and the vendor information. One or more vendor views include the product information and the customer information. The different views indicate, for example, rebate-eligible orders of a product by different distributors or customers, or multiple orders of a common product from different distributors or customers.

### CROSS-REFERENCE TO RELATED APPLICATIONS

This application is a continuation-in-part of co-pending U.S. application Ser. No. 14/881,240, filed Oct. 13, 2015, which is a continuation of U.S. application Ser. No. 12/574,050, filed Oct. 6, 2009, which is a continuation-in-part of U.S. application Ser. No. 10/860,986, filed Jun. 4, 2004 (abandoned), which claims priority from U.S. Provisional Application Ser. No. 60/475,587, filed Jun. 4, 2003. Each of the above-noted references are herein incorporated by reference in their entirety.

### TECHNICAL FIELD

The application generally relates to a method and apparatus for providing a marketing system and more particularly, to an Internet-based method and apparatus for providing a marketing system for tracking and managing sales incentive programs. For example, the method and apparatus can be an Internet-based method, platform and apparatus for enabling sales incentives and engagement across the foodservice supply chain.

### BACKGROUND

Electronic Sourcing Systems and purchasing systems that manage and process requisitions are known. One such system is the Electronic Sourcing System described in U.S. Pat. No. 6,505,172. This system provides an electronic sourcing method and system that provides a user with the capability of searching a database containing data (including product/vendor identification, and other product information) relating to items available from at least two vendor product catalogs, and the capability of transferring the product information for desired catalog items obtained as a result of the search to a requisition/purchasing system for use in generating a requisition including entries for the desired catalog items. Additionally, the invention provides an electronic sourcing system that provides a means for bi-directionally transferring information between a requisition/purchasing system that may use the results of a search of such product information, and a means for searching large volumes of product information such as would be included in a vendor product catalog. Furthermore, the system is capable of creating an order list including desired catalog items located as the result of such a database search, and transferring that order list to a requisition/purchasing system for generating a requisition including entries for the desired catalog items. The system includes a computer that maintains a catalog database of data including product information relating to catalog items available from vendor product catalogs, and a means for generating a requisition including at least one requisitioned item. Information at least partially identifying an item desired to be requisitioned is entered by a user, and utilized by a means for searching the database for catalog items matching that information and for selecting at least one catalog item located as a result of the search. Text describing the catalog items, and images of the items, may be viewed. Data identifying selected catalog items are communicated to the requisition building means, which generates a requisition including entries for items corresponding to the selected catalog items. Additionally, the invention includes a means for checking the availability in one or more inventory locations of the corresponding desired catalog items, and for generating one or more purchase orders for desired items from inventory locations stocking the items.

Additionally, methods and apparatus for disseminating product information via the internet are known. One such method and apparatus for disseminating product information via the internet is described in U.S. Pat. No. 6,418,441 (the '441 patent). The '441 patent provides a method and apparatus for delivering information about products and manufacturers via the Internet using all or part of the universal product codes which designate these products and manufacturers as Internet access keys. The product information is stored in Internet servers; for example in XML format, by the manufacturers who both produce the products and control the content of the stored product information.

This system further allows Internet shoppers and others who desire product information to view web pages via the Internet from on-line merchants and other sources. These web pages may contain one or more links to product information, and each such link contains a reference which designates a particular product by its corresponding universal product code. When the web browser operated by the shopper activates such a link, a request, message containing at least a portion of the universal product code is sent via the Internet to a cross-referencing database, preferably maintained by the Internet Domain Name Service, which returns the Internet address of the particular manufacturer's server which then makes the desired product information available. Additionally, the invention provides product information to web customers who visit web sites operated on behalf of retail stores which use universal product codes both for bar code checkout and to identify specific products in a computerized inventory control system. The retailer's inventory control systems need not store detailed product information since, by means of the invention, the universal product codes of items being offered for sale can be used to access product information directly from the manufacturer's servers.

Generally, a number of industries, and the foodservice industry in particular, provide incentive programs for the customers that use their products. The foodservice providers awards the customers with points, rebates, or other incentives in return for purchasing the designated items. The customers are then allowed to redeem these incentive points, or otherwise redeem their reward. For example, vendors and manufacturers fund these incentives as a means of direct marketing and to ensure customer loyalty to a brand. In furtherance of these goals, it is essential that these incentive programs to be communicated to customers and distributors alike, thereby assuring the greatest participation. Furthermore, it is essential that manufacturers and distributors have the ability to track and manage their incentive programs in order to measure the Return on Investment and success of their funded programs.

Presently, none of the known systems allow a customer or user to participate in multiple incentive programs via a single interactive internet based system. Furthermore, none of the known systems allow vendors to create, manage, and track their incentive programs utilizing the same interactive internet based system. Still furthermore, none of the existing systems currently allow distributors to approve, monitor, and manage the programs and point banks using the aforementioned interactive internet based system.

It would be desirable to provide a system that would allow a customer or user to participate in multiple incentive programs via a single interactive internet based system.

It would be desirable to provide a system that would allow one to easily identify new sales opportunities focused on those customers most likely to buy, as derived from or based on, historical sales analysis.

It would further be desirable to provide a system that would allow vendors to create, manage, and track their incentive programs utilizing the same interactive internet based system.

It would still further be desirable to provide a system that would allow distributors to approve, monitor, and manage the programs and point banks using the aforementioned interactive internet based system.

It would be desirable to provide a system in which the vendor or manufacturer can see and measure Return on Investment in essentially real time, with a high degree of accuracy and immediacy.

It would be desirable to provide a system that enables visibility to the manufacturer, distributor and customer across the foodservice supply chain to ensure honest, accurate and efficient marketing.

It would be desirable to provide a platform and system to engage customers, distributors and manufacturers in a new single common interface or community, in order to enhance their supply chain relationship, improve efficiency and reduce costs.

### SUMMARY

According to one embodiment, presented herein is an interactive Internet-based system that will allow customers to view, and participate in multiple incentive programs via said single interactive internet based system. The customers will be able to choose for themselves from a list of qualifying incentive programs. Additionally, the customers will be ready to track and control their participation, including the redemption of the aforementioned incentives.

This system allows vendors to create, manage, and track their incentive programs utilizing the same interactive internet based system. Vendors will be able to design, submit, and manage their own customer incentive programs and business activity down to the customer level, wherein the data is updated real time or daily.

Furthermore, the system allows distributors to approve, monitor, and manage the programs and point banks using the aforementioned interactive Internet-based system. For example, distributors and other users will be able to facilitate and efficiently manage the programs and transactions, thereby maximizing the returns for all parties such as in the food service industry.

In another embodiment, a system, method and computer program product for managing and/or presenting supply-chain data is presented. In one embodiment, the system includes a database for storing the supply-chain data and a server. The server is configured to present multiple role-specific user interfaces to multiple users. The multiple role-specific user interfaces include a distributor user interface, a customer user interface, and a vendor user interface presenting corresponding views. One or more distributor views include product information, pricing information, vendor information, and customer information. One or more customer views include the product information, the pricing information, and the vendor information. One or more vendor views include the product information and the customer information. The different views indicate, for example, rebate-eligible orders of a product by different distributors or customers, or multiple orders of a common product from different distributors or customers.

### BRIEF DESCRIPTION OF THE DRAWINGS

The invention as well as its features and advantages will become more apparent from the following Detailed Description and the accompanying drawings in which like reference numerals are used to represent like parts.

FIGS. 1a-1b depict computing nodes, in accordance with one or more aspects set forth herein;

FIG. 1c depicts a cloud computing environment, in accordance with one or more aspects set forth herein;

FIG. 1d depicts abstraction model layers, in accordance with one or more aspects set forth herein;

FIGS. 2a-2g are sample representations of a user login window and the customer selectable pages;

FIGS. 3a-3j are sample representations of Distributor or Administrator selectable pages;

FIGS. 4a-4h are sample representations of Distributor Sales Representative (DSR) selectable pages;

FIGS. 5a-5e are sample representations of manufacturer selectable pages;

FIGS. 6a-6f are sample representations of broker selectable pages;

FIG. 7 is a flow diagram illustrating one method of the invention;

FIGS. 8a-8f are sample representations of distributor and vendor selectable pages;

FIG. 9a is an exemplary block diagram of a system;

FIG. 9b depicts one or more embodiments of a process for managing and/or presenting supply chain data; and

FIG. 9c is a diagram illustrating further aspects of a process for managing and/or presenting supply chain data.

### DETAILED DESCRIPTION

The present disclosure provides, in part, a multiuser, cloud-based system that allows multiple participants of a supply-chain ecosystem to conduct and transact business, for example, by providing facilities (e.g., networks and servers) to access supply-chain data, perform supply-chain transactions, obtain customized reporting, manage inventory, place orders, and other similar functions. Advantageously, the system can functionally assign different roles to different users, and manage access to the data so that the different users acting in different roles have access to appropriate data and functionality. In one specific example, the system can provide any participant, such as the manufacturer or vendor, the ability to see the return on investment (ROI) on their marketing investment, down to the case and customer.

The presently disclosed system allows all supply chain participants, such as distributors, customers, vendors, trade organizations, and other participants (users) to use a single system as their primary system. Because of security and data segmentation features, each participant can make use of the system secure in the knowledge that their data is protected from misuse. In one example, the system may be maintained by one trusted member of the ecosystem, such as a distributor or a trade organization.

By contrast, conventional systems are typically designed from the point of view of a single main party, such as a distributor. To the extent that other parties, such as customers, are allowed access to conventional systems, such access is very limited in nature, and is for the convenience of the single main party.

The system described herein offers an alternate paradigm in which a single supply-chain database and server may be used by numerous ecosystem partners on an equal footing.

As another advantage, the system described herein allows a set of small ecosystem partners to effectively compete against large vertically integrated market participants. For example, a large vertically integrated market participant may be able to take on multiple roles, such as being both a vendor and a distributor of products. By contrast, smaller market participants may encounter difficulty when attempting to meet the needs of customers. Such a situation arises because of added complexity required for multiple small participants to meet the needs of a single customer in contrast with the ability of a single large participant being able to meet those needs.

The concepts described herein may be applied to multiple different industry ecosystems, and are described in one detailed embodiment with respect to the food distribution industry. For example, these concepts may be readily applied to medical device distribution, product sales, pharmaceutical supply-chains, airlines, the travel industry, etc.

Generally stated, the term “customer” may refer to an end-user of a product. A “product” may refer to a consumable or deliverable item which is requested or purchased by a customer. A “vendor” may refer to a manufacturer or producer of products. A “distributor” may refer to an aggregator, reseller or warehouser of multiple products from multiple vendors. A “trade organization” may refer to a member based organization consisting of numerous distributors who worked together, for example, to negotiate product pricing, conduct lobbying efforts, etc.

For instance, in the food service industry example, customers may include restaurants, hospitals and school systems. Products may include produce, meats, beverages and paper products, among others. Distributors generally may include product or service providers to foodservice operations including, but not limited to, foodservice distributors, equipment and supply distributors, beverage distributors, paper and disposable product distributors, chemical distributors, produce distributors, meat distributors, poultry distributors, seafood distributors, service companies, etc. Individual users within distributor organizations may be either Distributor Administrators or Distributor Sales Representatives (DSR). Distributor Administrators are those individuals assigned or empowered by the distributor or service provider with decision-making authority pertaining to the application described herein. Examples of these users may include senior management, corporate product category managers, sales managers, buyers, marketing managers, major account managers, etc. Distributor Sales Representatives (DSR) are those individuals within the distributor sales organization charged with management and/or execution of some portion of the sales process and interaction with the customer in the course of doing business. Examples of these users include: sales representatives, sales managers, major account managers, chain account managers, healthcare specialists, customer service representatives, inside sales representatives, etc.

Generally, vendors are defined as those business entities associated with the manufacturing, marketing, initial distribution and re-distribution of products to the distributors, as well as provision of products and/or services directly to the customers on behalf of the distributors. Vendors may either be manufactures and Brokers. Manufacturers are the companies, and their direct representatives, responsible for the actual manufacturing, processing, initial marketing and distribution of products and/or services to the distributors and their associated customers. Examples of these users include food manufacturers, food processors, agricultural product providers, chemical manufacturers, chemical service providers, equipment manufacturers, consolidated remarketing companies, etc. A single manufacturer may interact with multiple distributors, managing an individual account for each distributor location. Brokers are independently contracted third party representatives of the manufacturers, charged with marketing the products and services to the distributors and customers on behalf of that specific manufacturer. Brokers may have administration rights to manage programs for multiple manufactures at multiple distributor locations.

In a medical device industry example, customers may include doctor offices and hospitals. Products may include drugs, catheters and surgical tools. Vendors may include pharmaceutical companies, device manufacturers, etc. Distributors may include companies that specialize in dental, or other medical specialties.

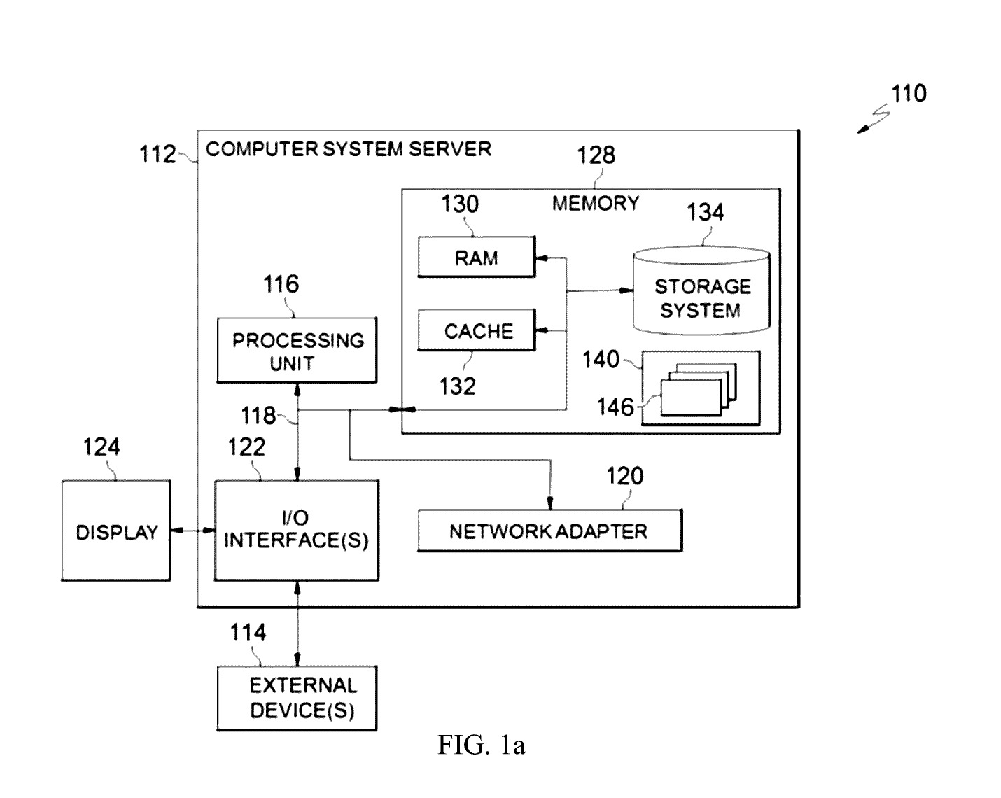

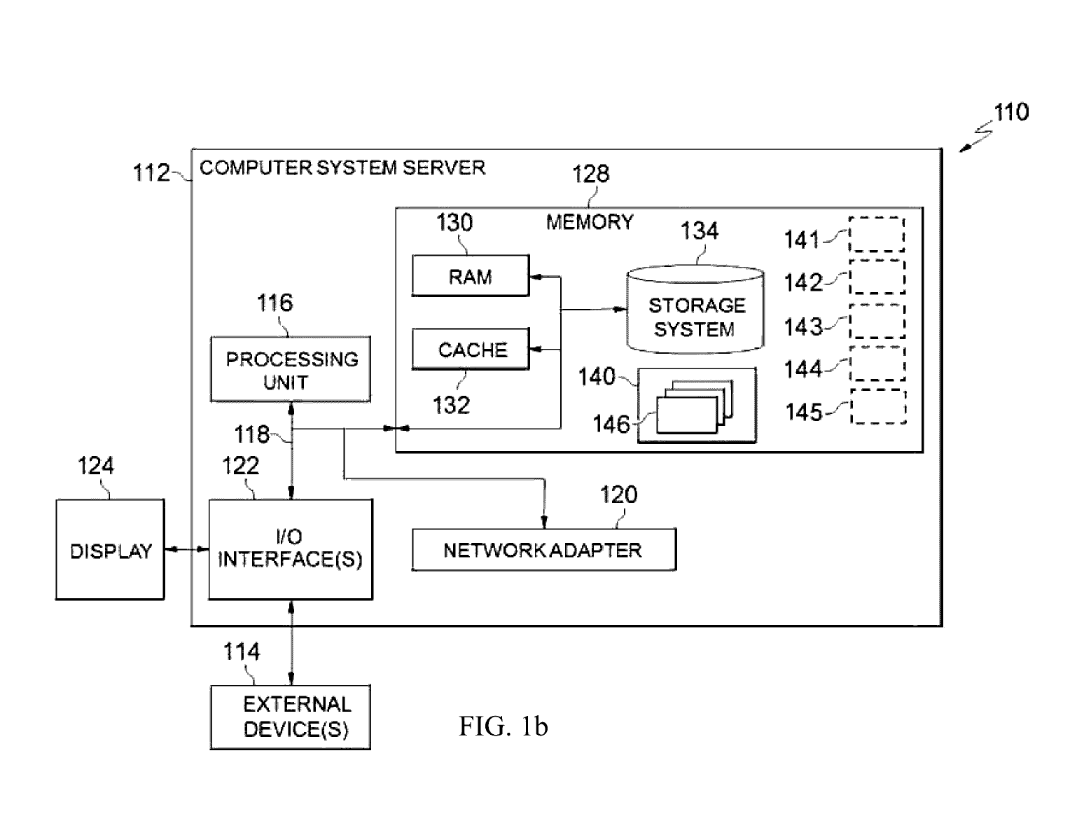

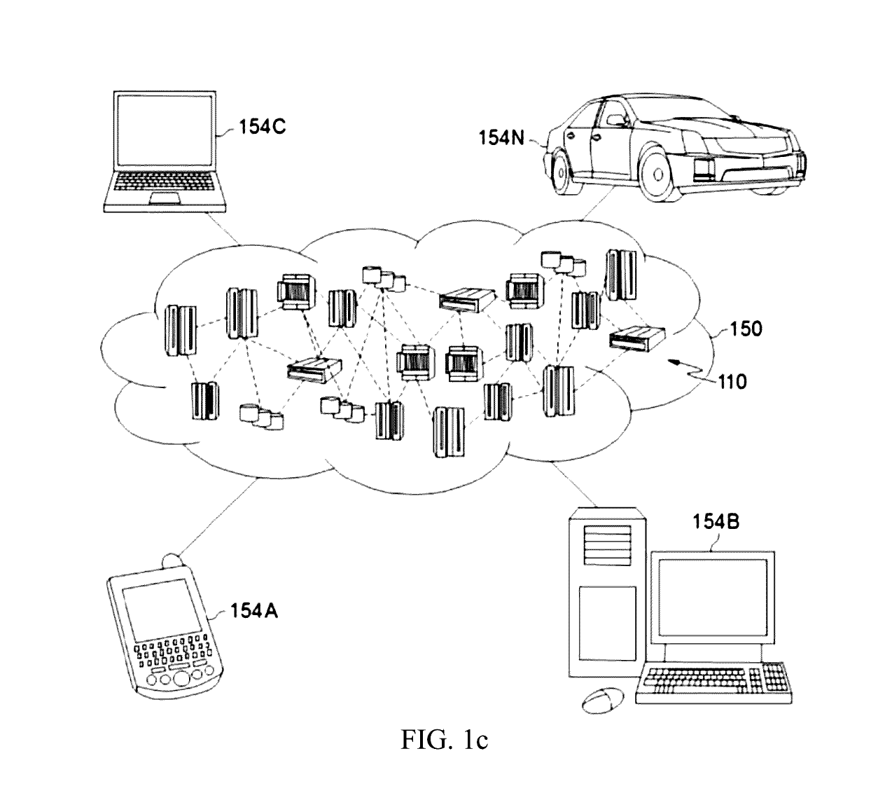

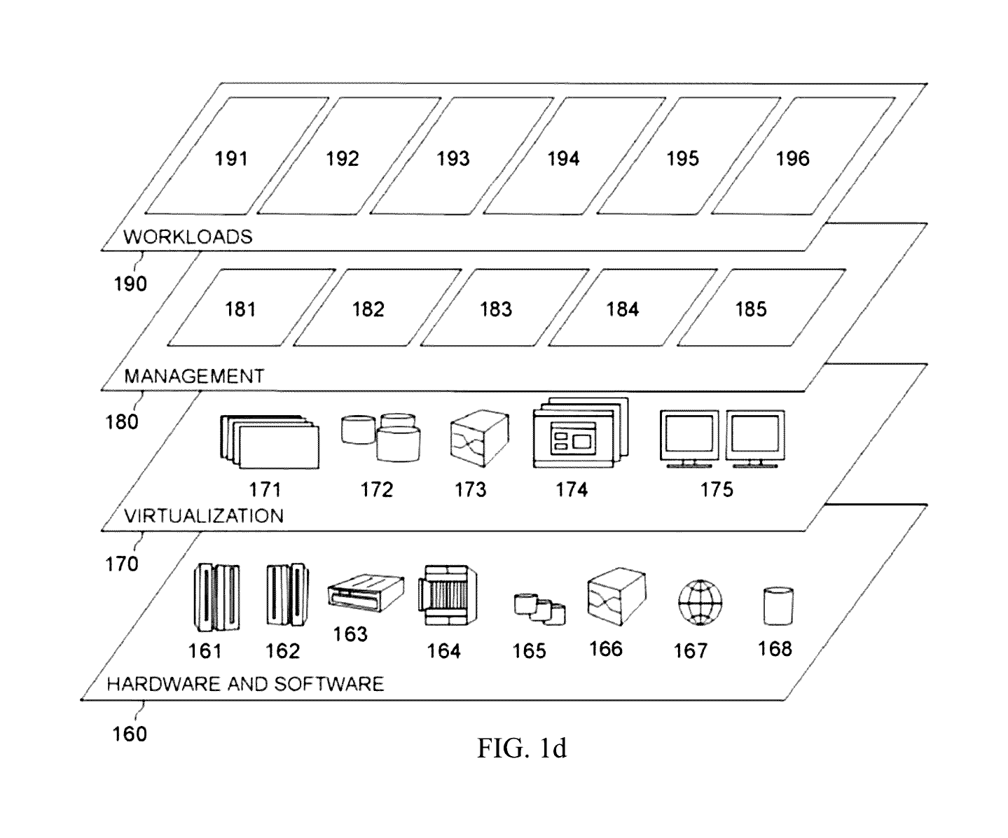

FIGS. 1a-1d depict various aspects of computing, including cloud computing, in accordance with one or more aspects set forth herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four (4) deployment models.

Characteristics are as follows:

On-demand self-service: a cloud user can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple users using a multi-tenant model, with different physical and virtual resources dynamically assigned and reassigned according to demand. There is a sense of location independence in that the user generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the user, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and user of the utilized service.

Service Models are as follows:

Software as a Service (SaaS): the capability provided to the user is to use the provider's applications running on a cloud infrastructure. The applications are accessible from various client devices through a thin client interface such as a web browser (e.g., web-based e-mail). The user does not manage or control the underlying cloud infrastructure including network, servers, operating systems, storage, or even individual application capabilities, with the possible exception of limited user-specific application configuration settings.

Platform as a Service (PaaS): the capability provided to the user is to deploy onto the cloud infrastructure user-created or acquired applications created using programming languages and tools supported by the provider. The user does not manage or control the underlying cloud infrastructure including networks, servers, operating systems, or storage, but has control over the deployed applications and possibly application hosting environment configurations.

Infrastructure as a Service (IaaS): the capability provided to the user is to provision processing, storage, networks, and other fundamental computing resources where the user is able to deploy and run arbitrary software, which can include operating systems and applications. The user does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 1a, a schematic of an example of a cloud computing node is shown. Cloud computing node 110 is only one example of a suitable cloud computing node and is not intended to suggest any limitation as to the scope of use or functionality of embodiments of the invention described herein. Regardless, cloud computing node 110 is capable of being implemented and/or performing any of the functionality set forth hereinabove.

In cloud computing node 110 there is a computer system/server 112, which is operational with numerous other general purpose or special purpose computing system environments or configurations. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor-based systems, set top boxes, programmable user electronics, network PCs, minicomputer systems, mainframe computer systems, and distributed cloud computing environments that include any of the above systems or devices, and the like.

Computer system/server 112 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 112 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, a computer system/server 112 in cloud computing node 110 is shown in the form of a general-purpose computing device. The components of computer system/server 112 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of computer system readable media. Such media may be any available media that is accessible by computer system/server 112, including both volatile and non-volatile media, removable media and non-removable media.

System memory 128 can include computer system readable media in the form of volatile memory, such as random access memory (RAM) 130 and/or cache memory 132. Computer system/server 112 may further include other removable/non-removable, volatile/non-volatile computer system storage media. By way of example only, storage system 134 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 118 by one or more data media interfaces. As will be further depicted and described below, memory 128 may include at least one program product having a set (e.g., at least one) of program modules that are configured to carry out the functions of various embodiments and versions.

Program/utility 140, having a set (at least one) of program modules 146, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 146 generally carry out the functions and/or methodologies of embodiments and versions, as described herein.

Computer system/server 112 may also communicate with one or more external devices 114 such as a keyboard, a pointing device, a display 124, etc.; one or more devices that enable a user to interact with a computer system/server 112; and/or any devices (e.g., network card, modem, etc.) that enable the computer system/server 112 to communicate with one or more other computing devices. Such communication can occur via Input/Output (I/O) interfaces 122. In addition, the computer system/server 112 can communicate with one or more networks such as a local area network (LAN), a general wide area network (WAN), and/or a public network (e.g., the Internet) via a network adapter 120. As depicted, the network adapter 120 communicates with the other components of computer system/server 112 via the bus 118. It should be understood that although not shown, other hardware and/or software components could be used in conjunction with computer system/server 112. Examples, include, but are not limited to: microcode, device drivers, redundant processing units, external disk drive arrays, RAID systems, tape drives, and data archival storage systems, etc.

FIG. 1b depicts a hardware overview of a computing node 110, which may be a cloud computing node, in accordance with one or more aspects set forth herein. By way of example, the computing node 110 may generally be any of the computing devices described herein, such as network devices, client computers, server computers, etc.

Program/utility 140 as set forth in FIGS. 1a-1b can optionally include some or all of one or more programs 141, 142, 143, 144, 145. One or more program 140 can have a set (at least one) of program modules, and may be stored in memory 128 by way of example, and not limitation, as well as an operating system, one or more application programs, other program modules, and program data. Each of the operating system, one or more application programs, other program modules, program data, and one or more program, or some combination thereof, may include an implementation of a networking environment.

Referring now to FIG. 1c, an illustrative cloud computing environment 150 is depicted. As shown, cloud computing environment 150 comprises one or more cloud computing nodes 110 with which local computing devices used by cloud users, such as, for example, a personal digital assistant (PDA) or cellular telephone 154A, desktop computer 154B, laptop computer 154C, and/or automobile computer system 154N may communicate. Nodes 110 may communicate with one another. The nodes 110 may be grouped (not shown) physically or virtually, in one or more networks, such as Private, Community, Public, or Hybrid clouds as described hereinabove, or a combination thereof. This allows the cloud computing environment 150 to offer infrastructure, platforms and/or software as services for which a cloud user does not need to maintain resources on a local computing device. It is understood that the types of computing devices 154A-N shown in FIG. 1c are intended to be illustrative only and that computing nodes 110 and cloud computing environment 150 can communicate with any type of computerized device over any type of network and/or network addressable connection (e.g., using a web browser).

Referring now to FIG. 1d, a set of functional abstraction layers provided by the cloud computing environment 150 (FIG. 1c) is shown. It should be understood in advance that the components, layers, and functions shown in FIG. 1d are intended to be illustrative only and embodiments of the invention are not limited thereto. As depicted, the following layers and corresponding functions are provided:

A hardware and software layer 160 includes hardware and software components. Examples of hardware components include: mainframes 161; RISC (Reduced Instruction Set Computer) architecture based servers 162; servers 163; blade servers 164; storage devices 165; and networks and networking components 166. In some embodiments, software components include network application server software 167 and database software 168.

A visualization layer 170 provides an abstraction layer from which the following examples of virtual entities may be provided: virtual servers 171; virtual storage 172; virtual networks 173, including virtual private networks; virtual applications and operating systems 174; and virtual clients 175.

In one example, a management layer 180 may provide the functions described below. Resource provisioning 181 provides dynamic procurement of computing resources and other resources that are utilized to perform tasks within the cloud computing environment. Metering and Pricing 182 provide cost tracking as resources are utilized within the cloud computing environment, and billing or invoicing for consumption of these resources. In one example, these resources may comprise application software licenses. Security provides identity verification for cloud users and tasks, as well as protection for data and other resources. User portal 183 provides access to the cloud computing environment for users (consumers) and system administrators. Service level management 184 provides cloud computing resource allocation and management such that required service levels are met. Service Level Agreement (SLA) planning and fulfillment 185 provide pre-arrangement for, and procurement of, cloud computing resources for which a future requirement is anticipated in accordance with an SLA.

A workloads layer 190 provides examples of functionality for which the cloud computing environment may be utilized. Examples of workloads and functions which may be provided from this layer include: mapping and navigation 191; software development and lifecycle management 192; virtual classroom education delivery 193; data analytics processing 194; transaction processing 195; and a system for managing and/or presenting supply chain data 196, as described herein.

By way of example, one or more programs 140, and optionally at least one of one or more programs 141, 142, 143, 144, 145, as described in FIGS. 1a-1b, generally carry out the functions and/or methodologies of various embodiments of the invention as described herein, such as managing and/or presenting a supply chain data 196.

Referring again to FIGS. 1a-1b, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present apparatus and method.

Aspects of the apparatus and method are described herein with reference to flowchart illustrations and/or block diagrams of methods, apparatus (systems), and computer program products according to various embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the apparatus and method. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

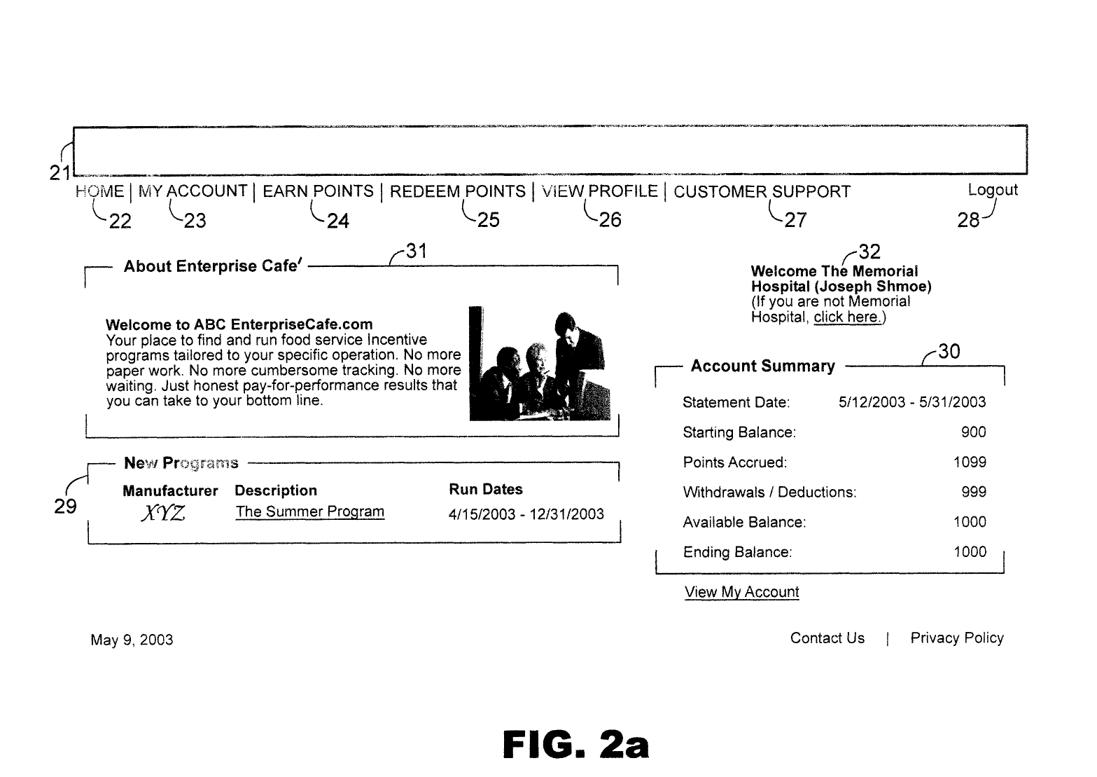

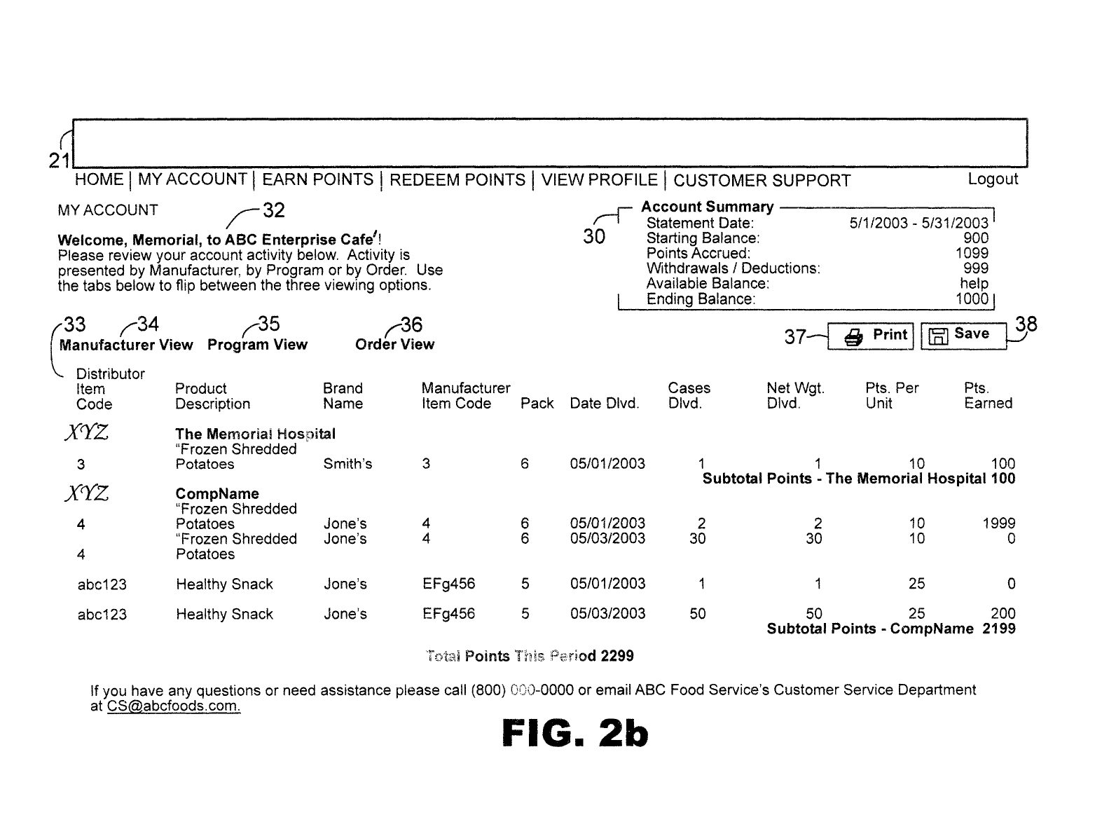

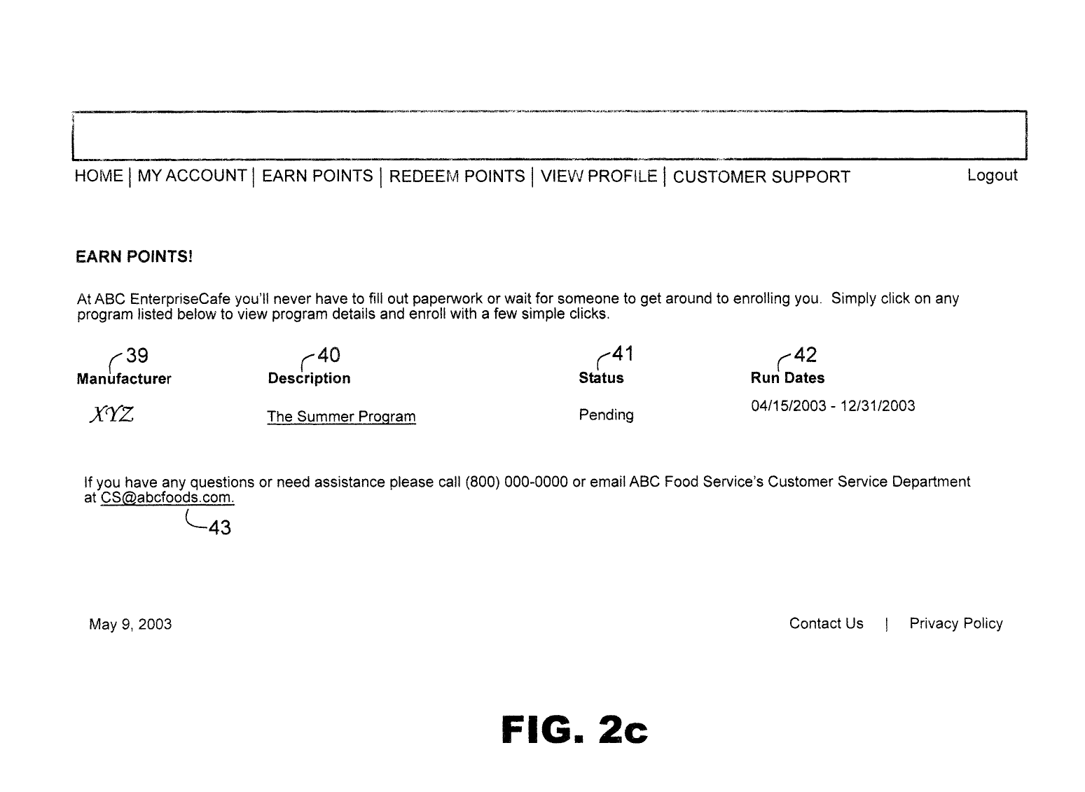

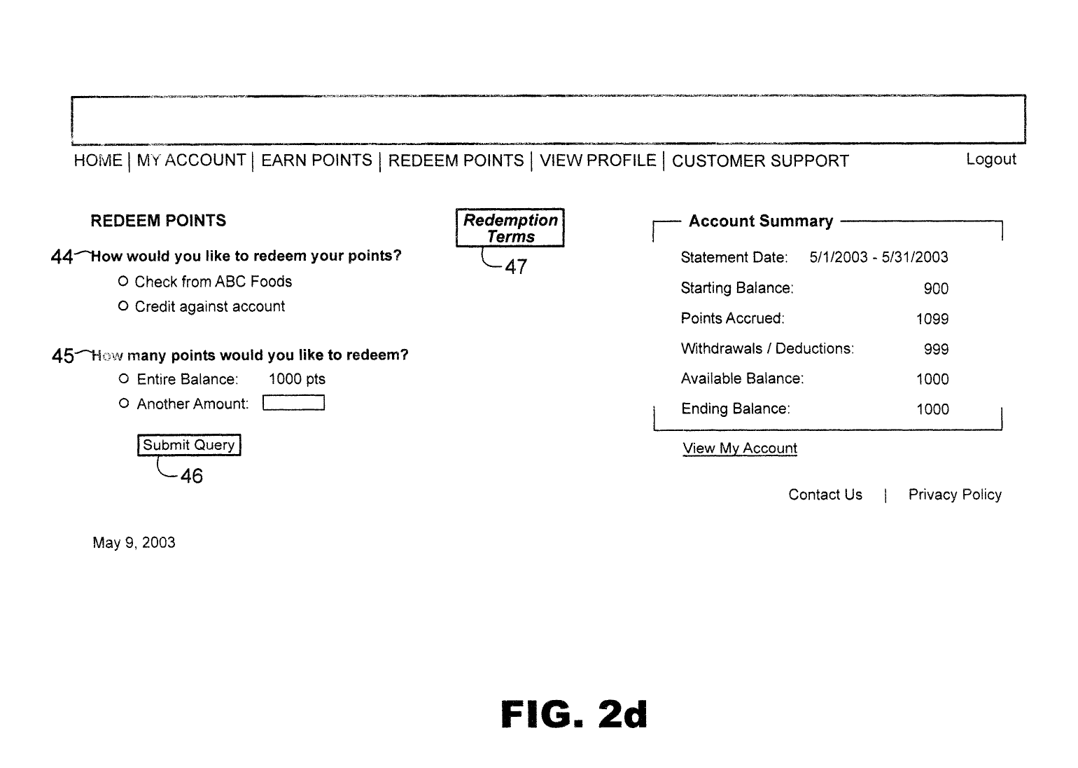

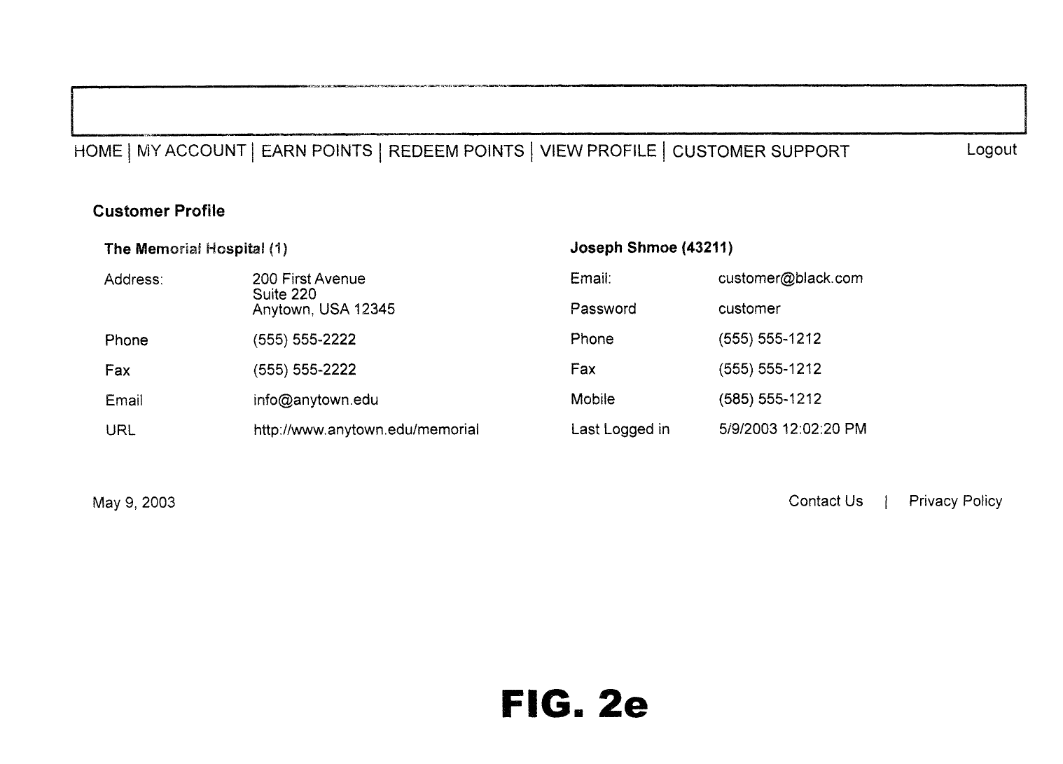

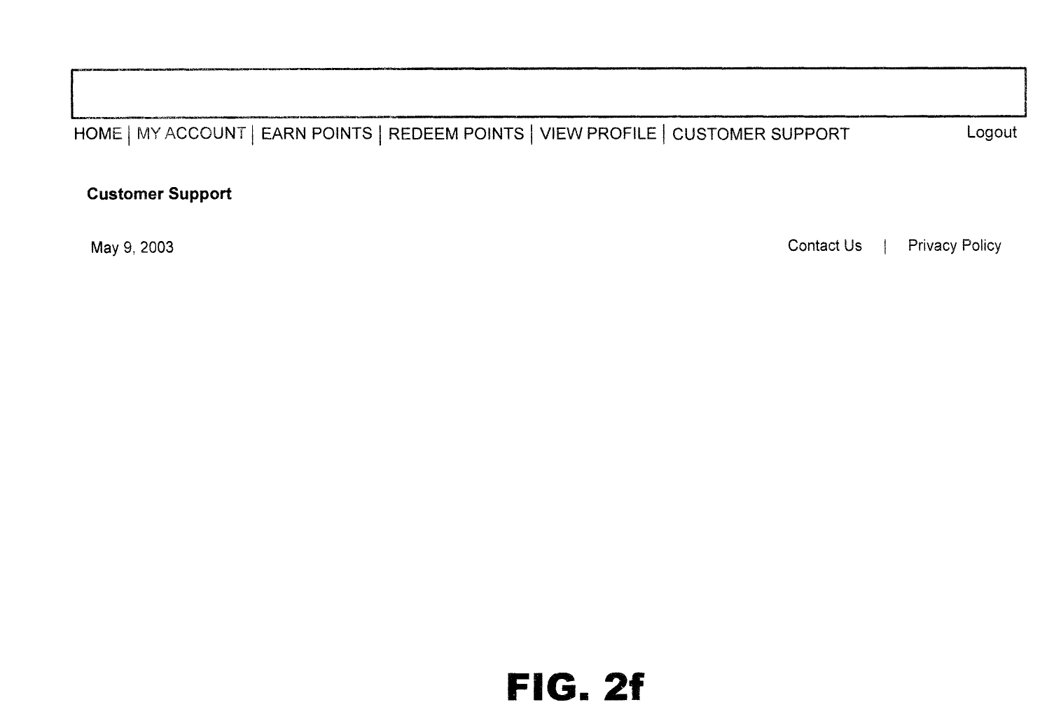

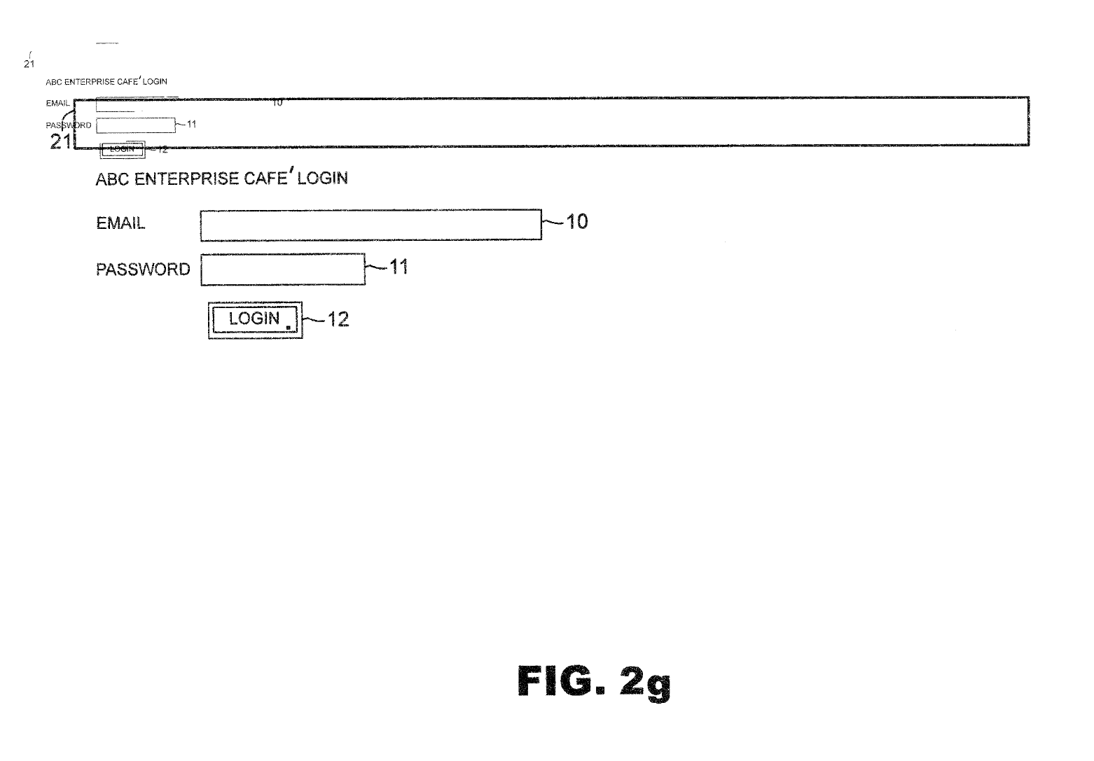

Referring generally to FIGS. 2a-2g, and more particularly FIG. 2g, a page displaying a general log-in interface is shown. The user or consumer may request entry to the application by submitting an identifier that identifies the user, such as, for example, an e-mail address 10 and password 11, and subsequently selecting a login icon 12. Based on the level of access granted to the user, the user will gain admittance to an authorized area (including, but not limited to the customer interface, the distributor interface, or the vender interface).

Referring to FIGS. 2a-2f, a series of pages, representing the customer interface according to this embodiment, are shown. Referring particularly to FIG. 2a, an example of a customer home page is shown. Generally, customers will reach a sign-in page, FIG. 2g, using a specific independent URL assigned to a participating Distributor by the Company. A link to this unique URL will be placed on the participating distributor's web site. By clicking on this link, the user will open a new browser window and be directed to the designated URL residing within the Company's web application. The URL and application will not normally reside within the URL or domain of the Distributor.

As indicated above, customers will enter the application from a secure sign-in page, FIG. 2g, using a Customer Number or e-mail 10 and password 11 (both assigned by the Distributor). The system will recognize the Customer's sign-in and allow access to the appropriate areas of the application as assigned by the Distributor Administrator. First-time users will need to obtain their password 11 from the associated Distributor Administrator. Customers not having email or web access may be set-up directly by the participating distributor rather than through the use of e-mail activation. When setting up such a customer, the distributor administrator will designate within the profile that the customer is to receive monthly printed statements.

Some of the displayed/selectable options (FIGS. 2a-2f) available to the users include, but are not limited to; viewing account activity; viewing and applying for available programs (including details and terms); checking the status of the programs; redeeming accrued points.

Referring again to FIG. 2a, the customer homepage is the starting point from which the customer may choose from a series of options. Generally, the top of each page may include a banner 21, that could be utilized for various functions, such as, for example, source identification or advertisements. According to this embodiment and immediately below the aforementioned banner 21, a series of operator (i.e., customer) selectable alternatives are displayed. By selecting the HOME option 22, the operator will access the customer home page, FIG. 2a. The HOME page may display information pertaining to New programs 29, Account Summary 30, or other information such as a website branding notification 31 and a customer welcome notification 32. The Account Summary 30 shall provide the customer a summary of activity including, but not limited to, Statement Date, Starting Balance, Points Accrued, Withdrawals/Deductions, Available Balance, and Ending Balance. This summary of activity may be computed for the specific customer from the information present in the database, and provides a general overview of the status of the rewards programs.

Referring now to FIG. 2b, the MY Account page is shown. As with the previous page, a banner may appear at the top of the page. Additionally, an array of selectable options are located below the banner. Furthermore, this page may include a welcome statement 32 and an account summary 30. This page provides additional detailed activity, as well as program information tables 33. The program information tables 33 may include information such as, “Distributor Item Code”, “Product Description”, “Brand Name”, “Manufacturer Code”, “Pack”, “Date Delivered.”, “Cases Delivered.”, “Net Weight Delivered”, ‘Points Per Unit”, and “Points Earned.” At the operator's preference, these tables 33 can be viewed from either a Manufacturing view 34 (as illustrated in FIG. 2c), a Program view 35, or an Order view 36. While the aforementioned views are displayed as selectable options, additional view options are contemplated. Furthermore, the program provides the operator the option of printing or saving tables. The tables may be printed by selecting the print option 37, or saved by selecting the save option 38. In the example of FIG. 2b, the program information tables 33 itemize each of the currently active incentive programs, and the qualifying customer activity that has been credited towards earned points.

Referring now to FIG. 2c, an Earn Points page is shown. The Earn Points page is selectable from any of the operator accessible pages by selecting the Earn Points option 24 below the banner 21. The Earn Points page (FIG. 2d) may display a list of available programs that are selectable by the operator. The list may include categories such as, Manufacturer 39, Description 40, Status 41, and Run Dates 42. Additionally, the page may provide the user with a phone number, or a link to an e-mail address 43, enabling the operator access to customer assistance. The list of available programs may include both programs that are currently being used by the customer (e.g., as reflected in FIG. 2b) and other programs that are not currently being used by the customer.

Referring to FIG. 2d, a Redeem Points page is shown. Generally, this page provides the customers/users a means to redeem a portion or all of the points accumulated through program purchases. The first selectable option 44 allows the operator to choose “How would you like to redeem, your points?”. The operator may choose between a “check from ABC foods”, or “credit against account.” For example, the system can either initiate the creation of a printed check to be mailed to the customer or for a credit to be entered against the customers outstanding balance. While these two options are displayed in FIG. 2d, other options are contemplated. An additional selectable option 45 allows the operator to choose “how many points would you like to redeem?”. The interface allows the operator to either redeem the entire balance of accumulated points earned, or another amount. The operator's current balance may be displayed adjacent to the “Entire Balance” option. A space is provided adjacent to the “Another Amount” option, allowing the operator to enter/input a specific amount of points. Upon completion of the aforementioned selections, the operator can select/click the “Submit Query” button. Additionally, this page includes an Account Summary section and a “Redemption Terms” button 47, enabling the operator to access the redemption terms.

Referring now to FIG. 2e, a Customer Profile page is shown. The page is accessible by selecting the “View Profile” option 26 on the aforementioned customer pages.

The customer accessible pages according to this embodiment further comprise a “Customer Support Page”, FIG. 2f, that can provide answers to frequently asked questions, links, or live support.

When the operator chooses to exit the program, the operator may do so by selecting the “Logout” option, the latter being available on each page according to this described embodiment.

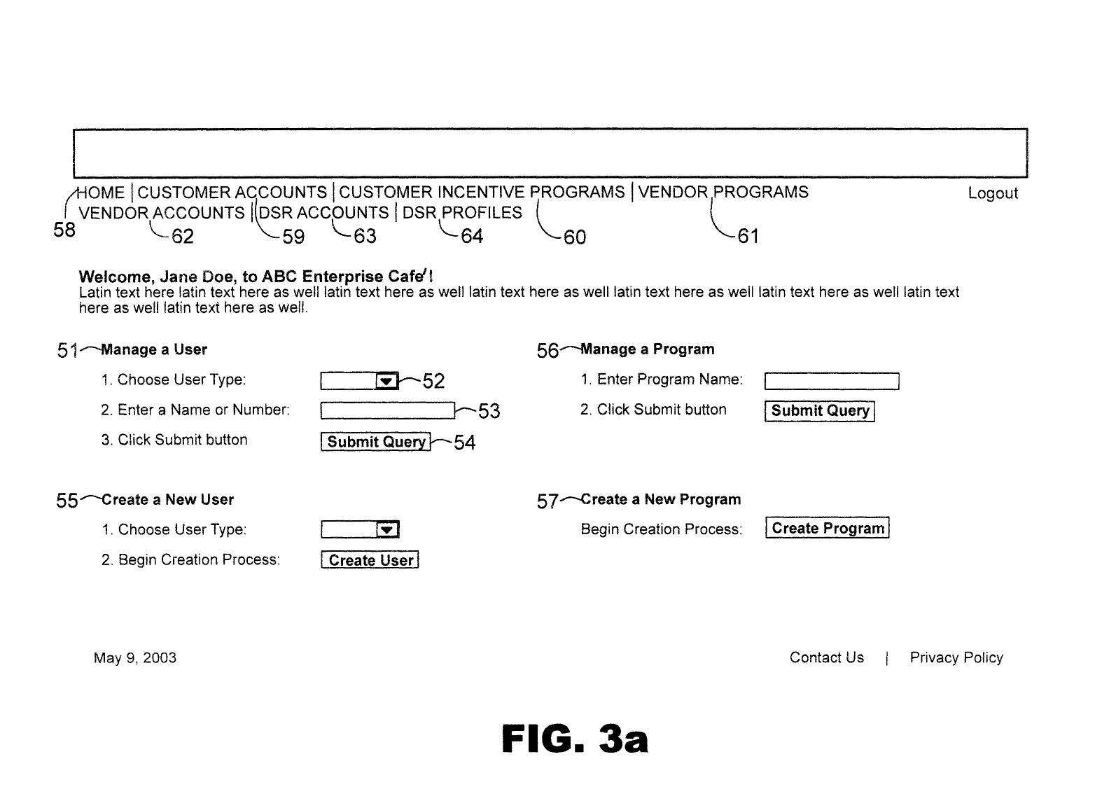

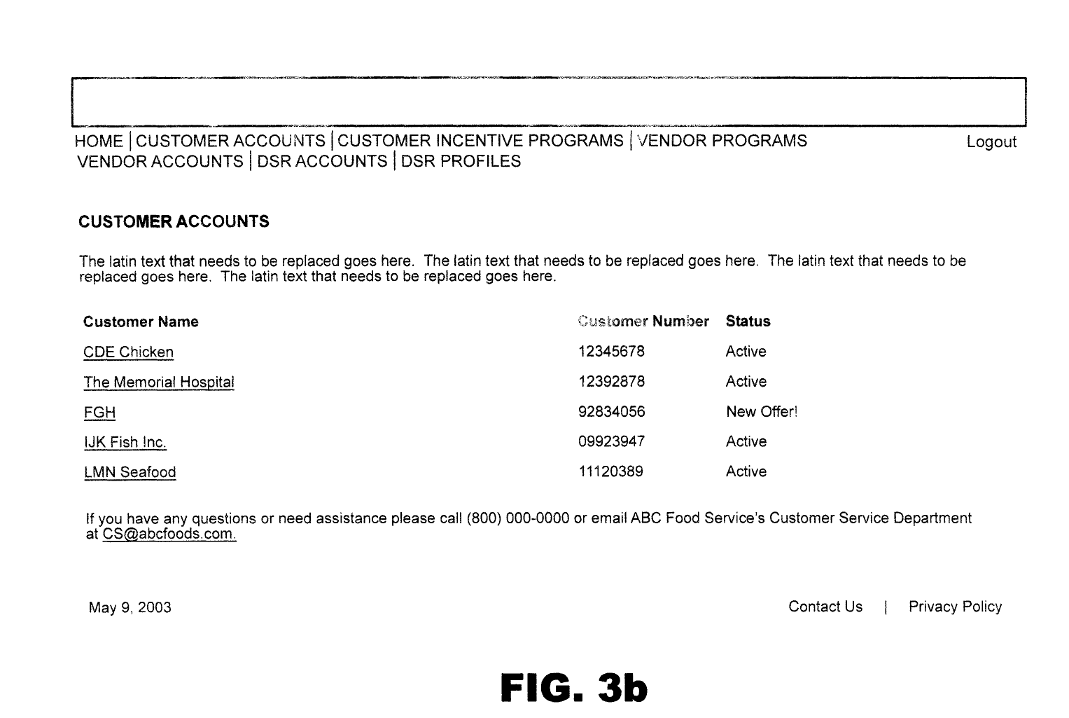

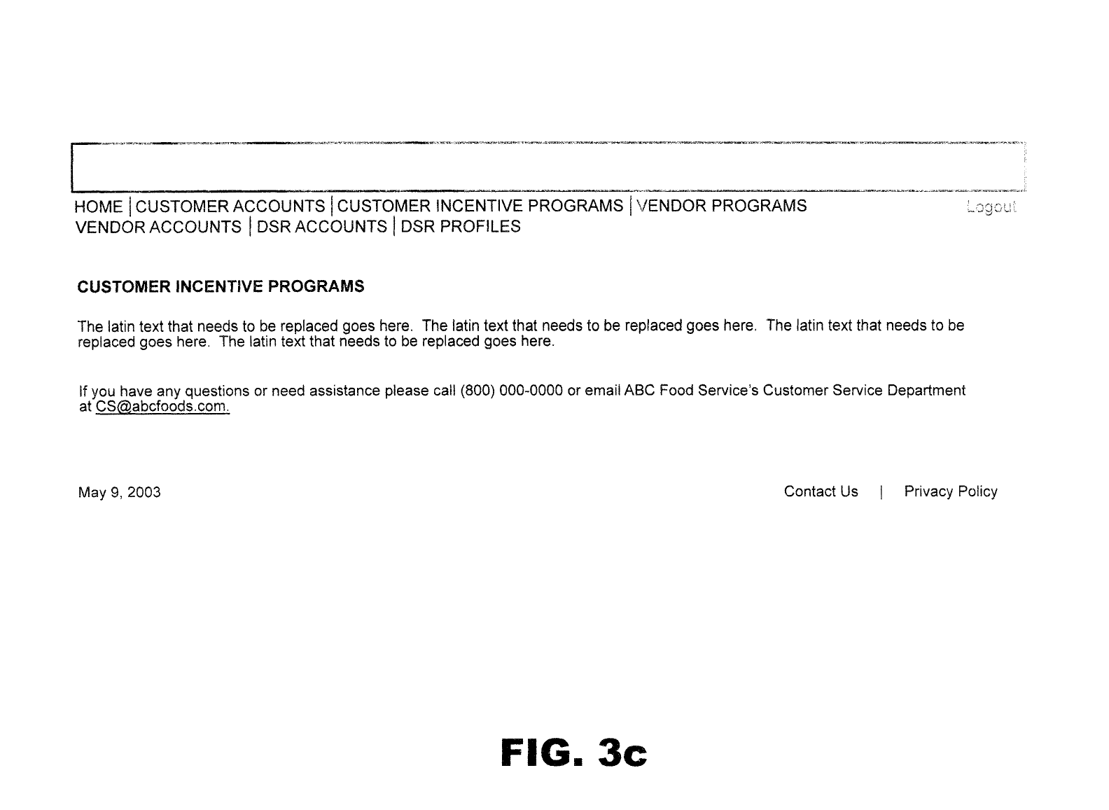

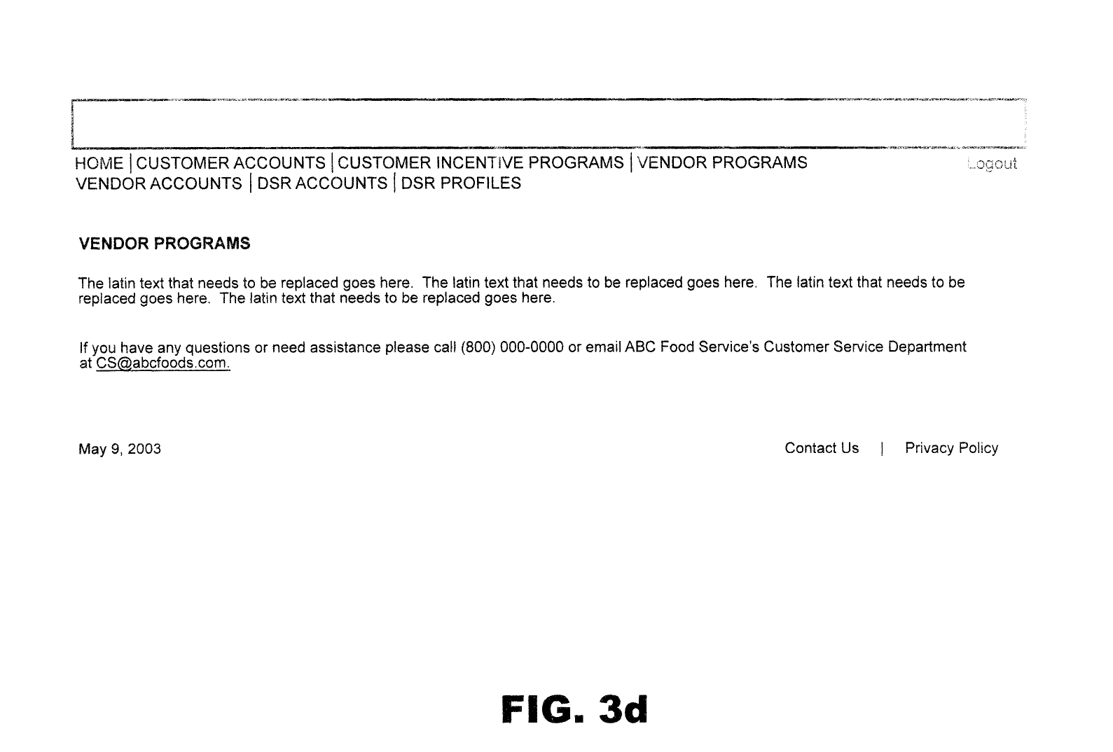

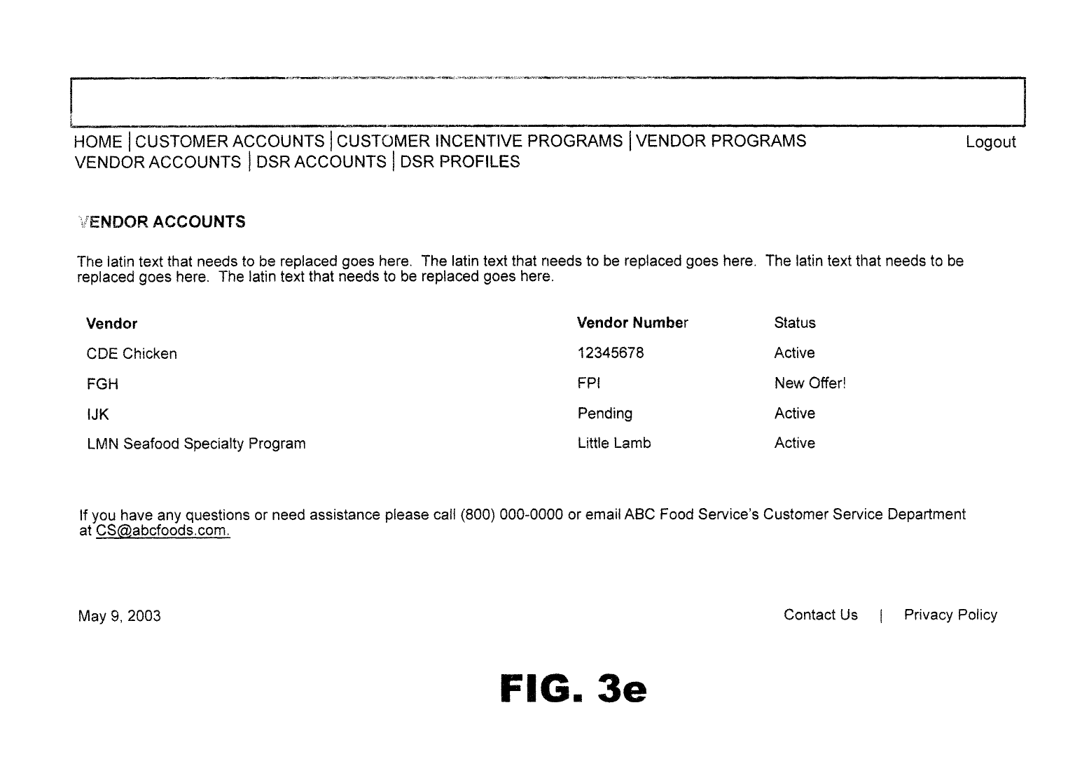

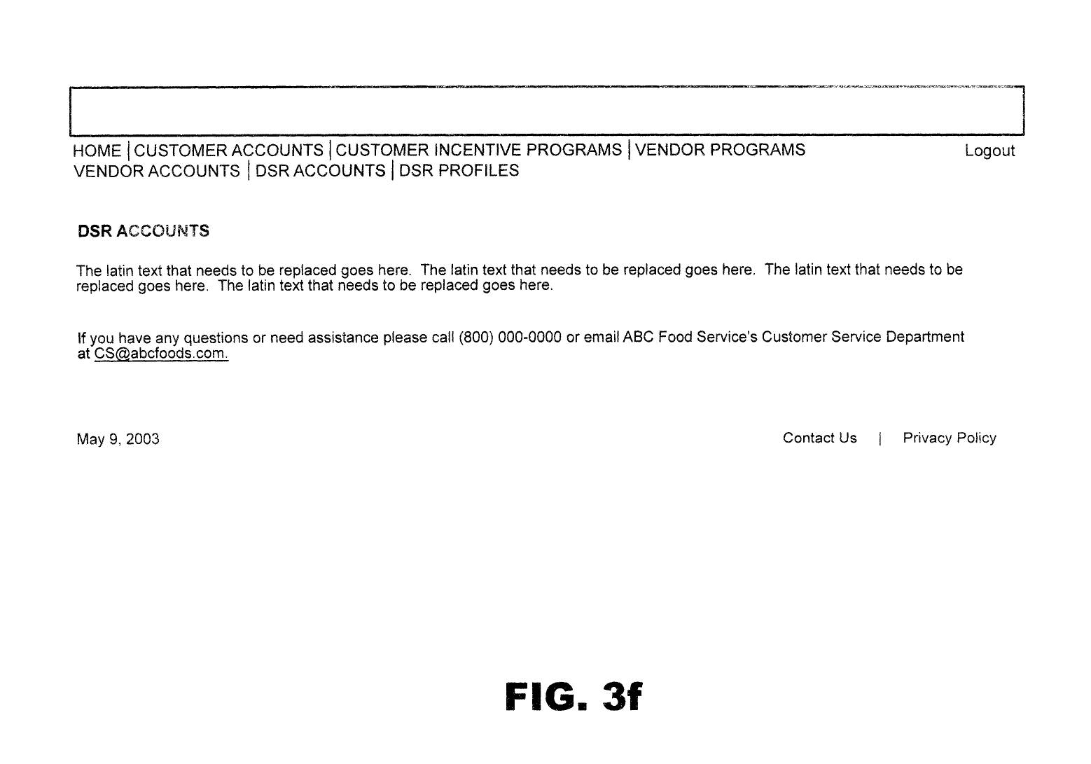

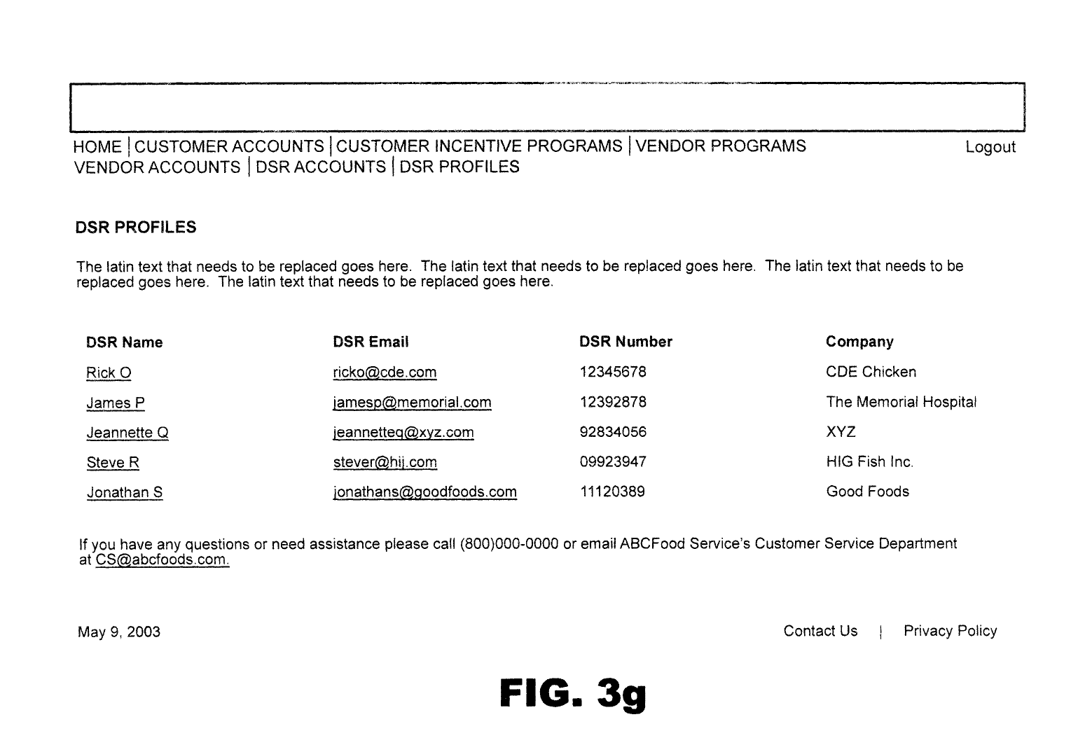

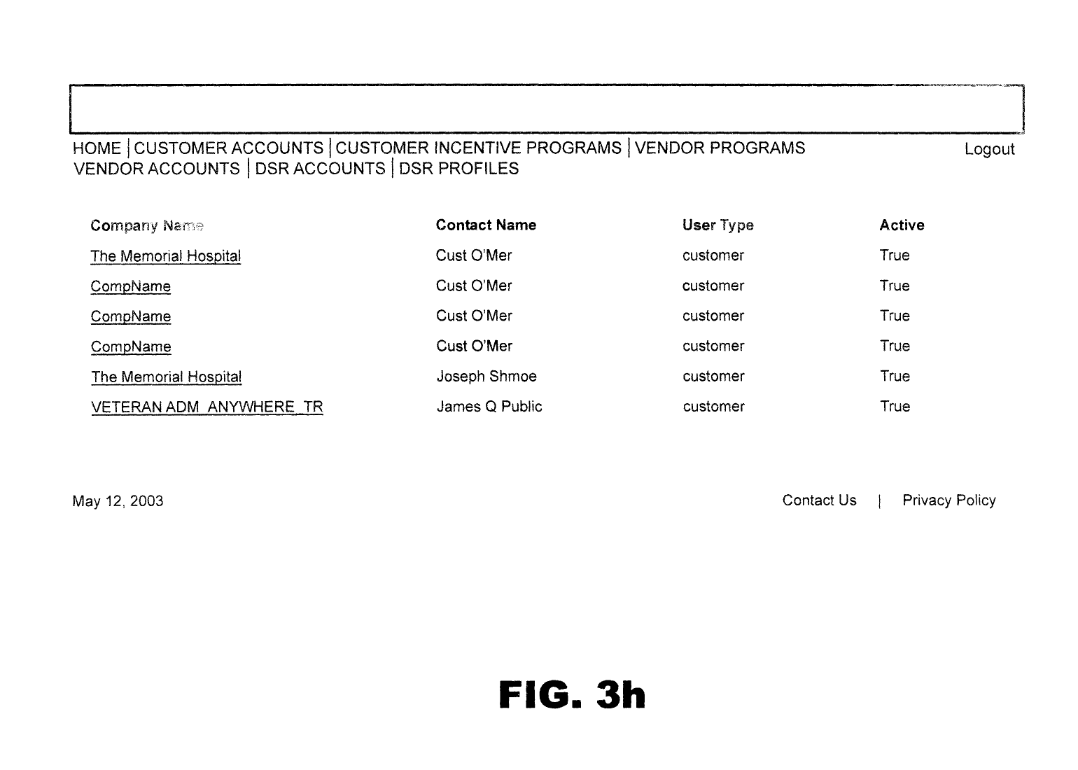

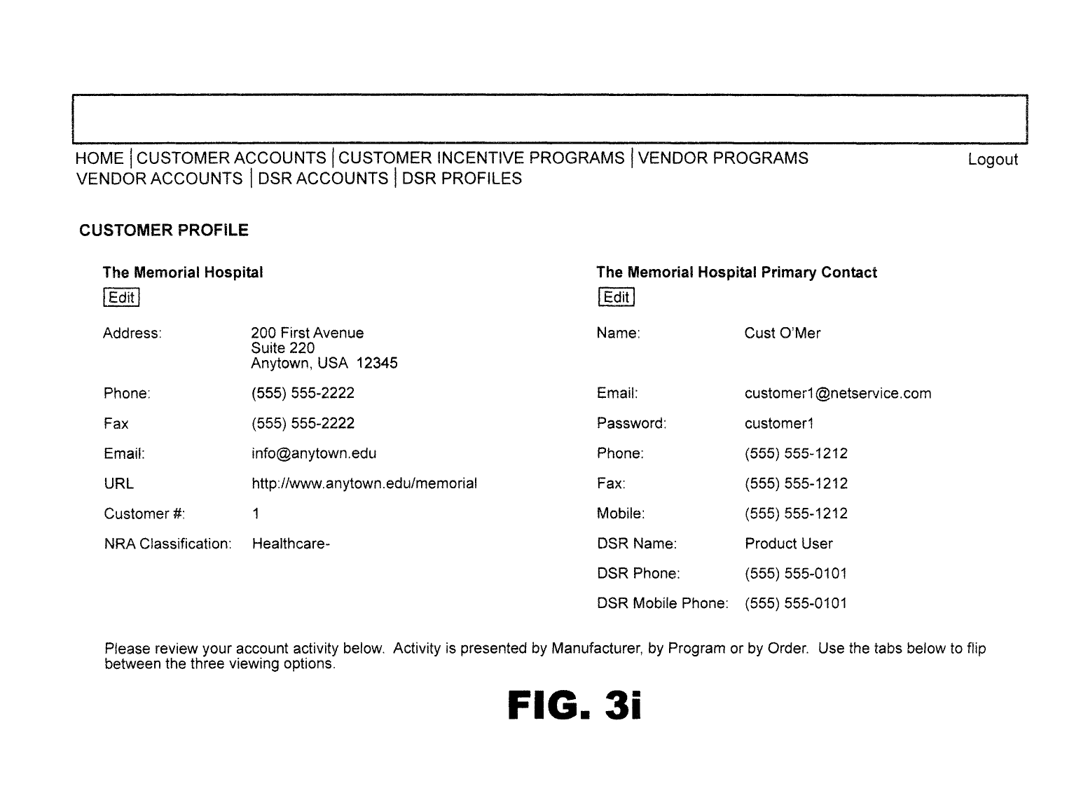

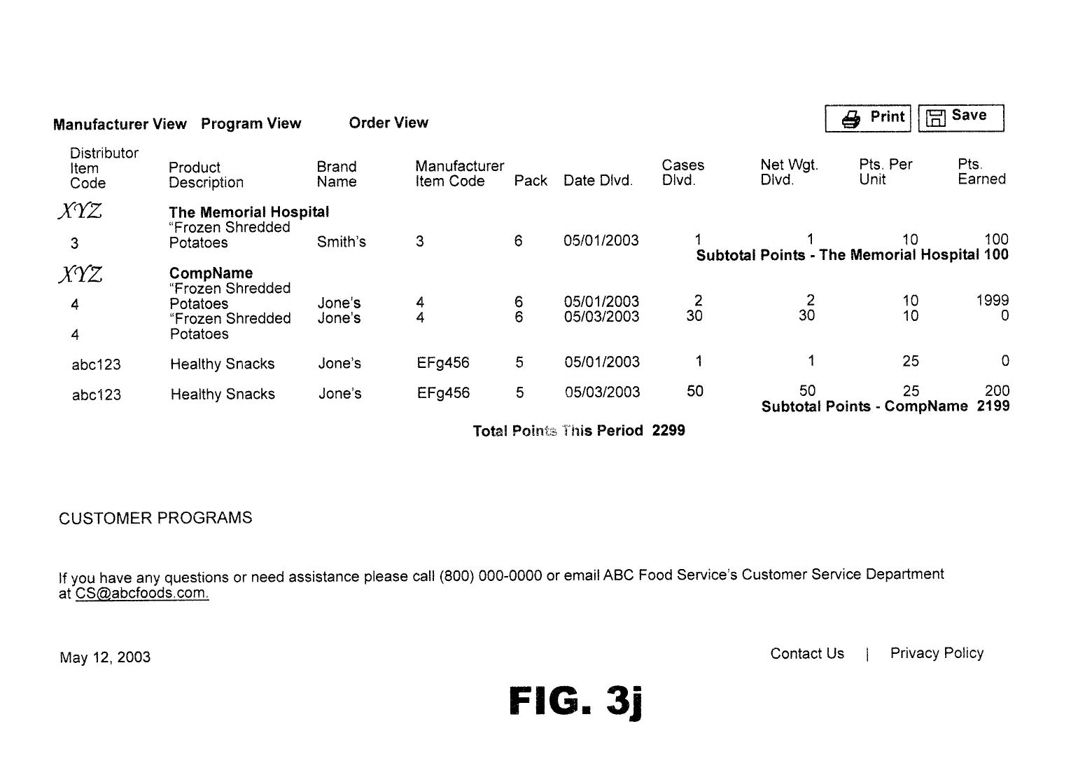

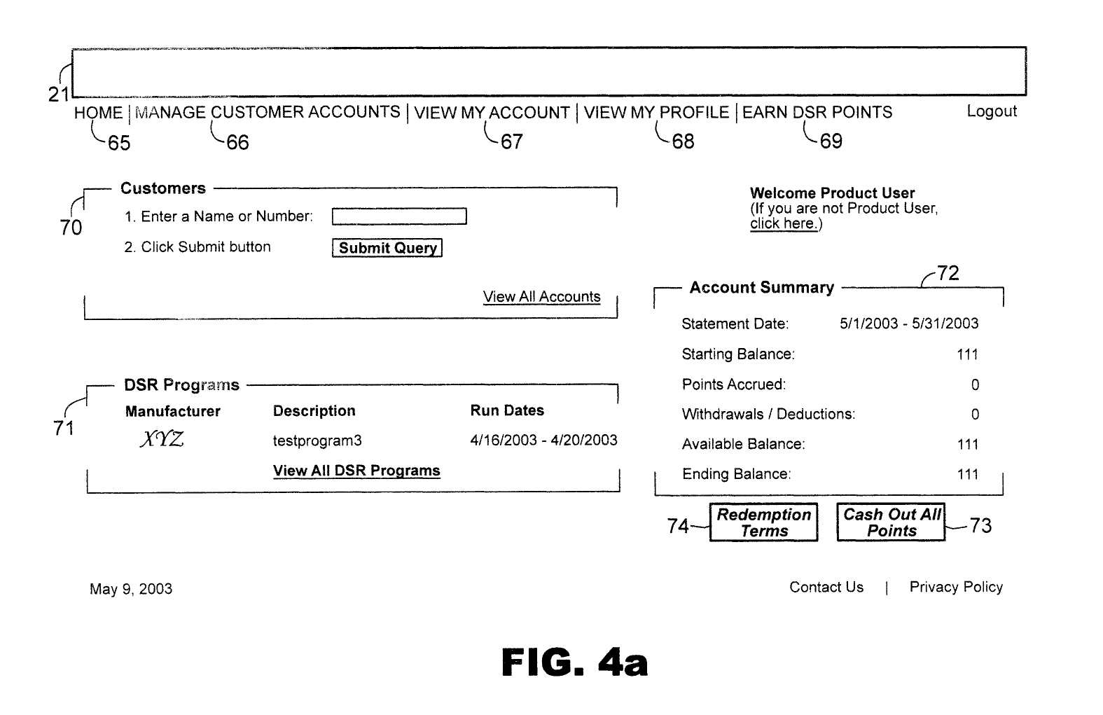

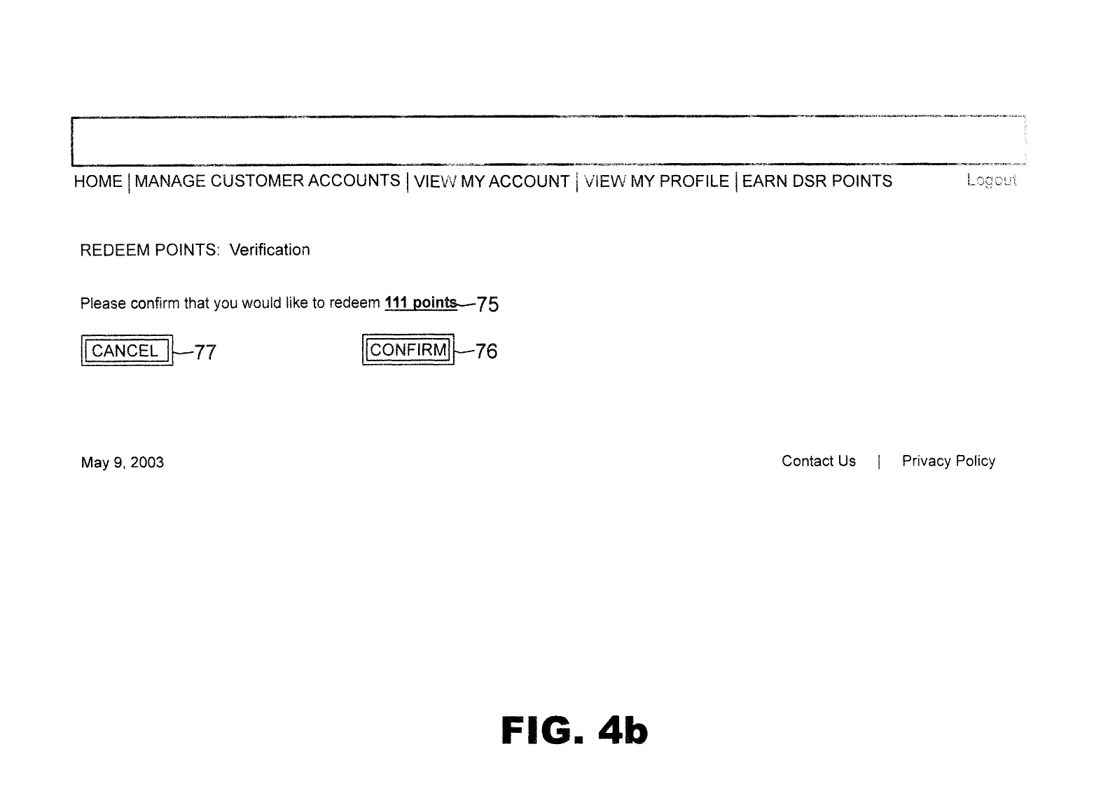

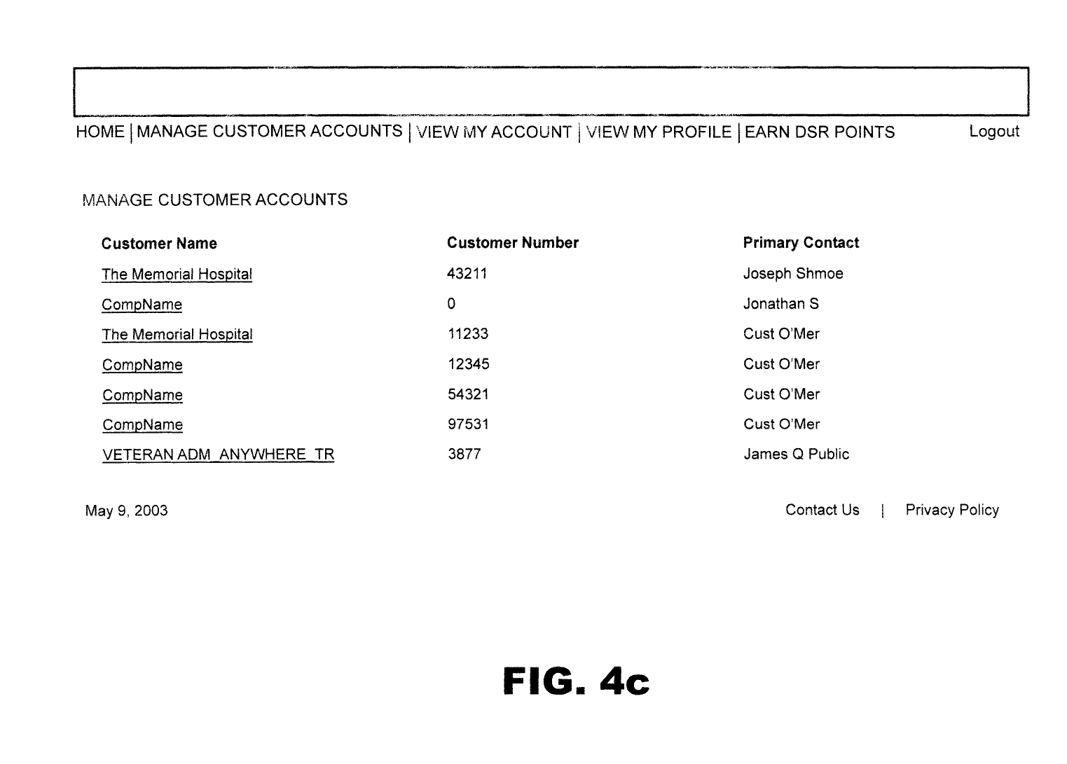

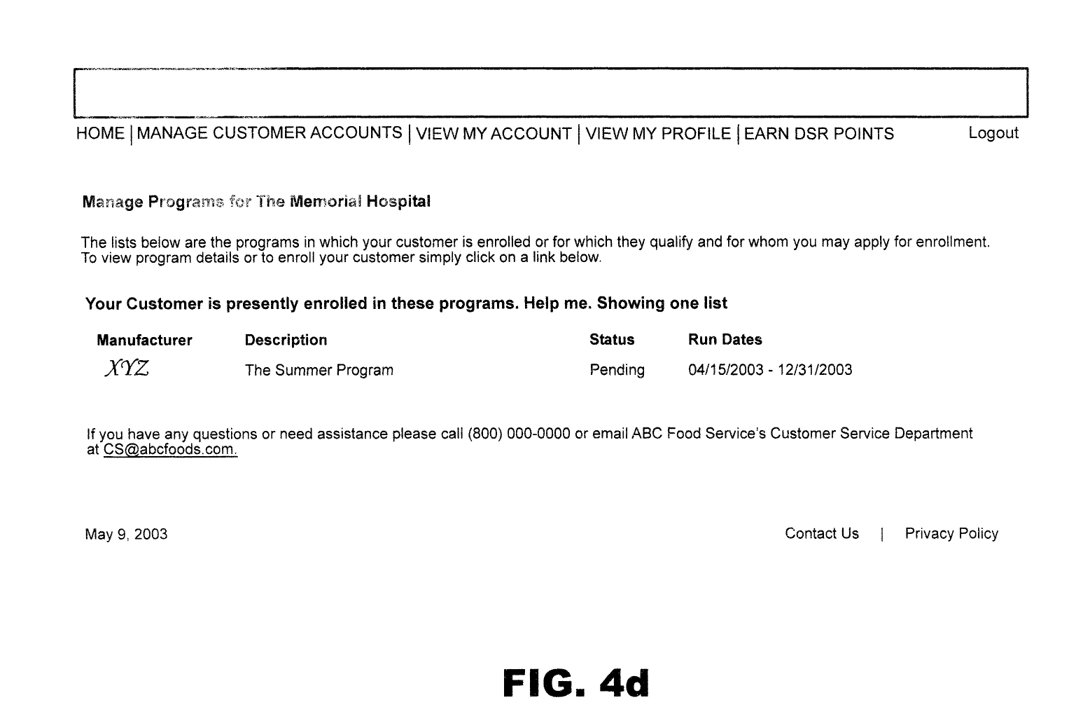

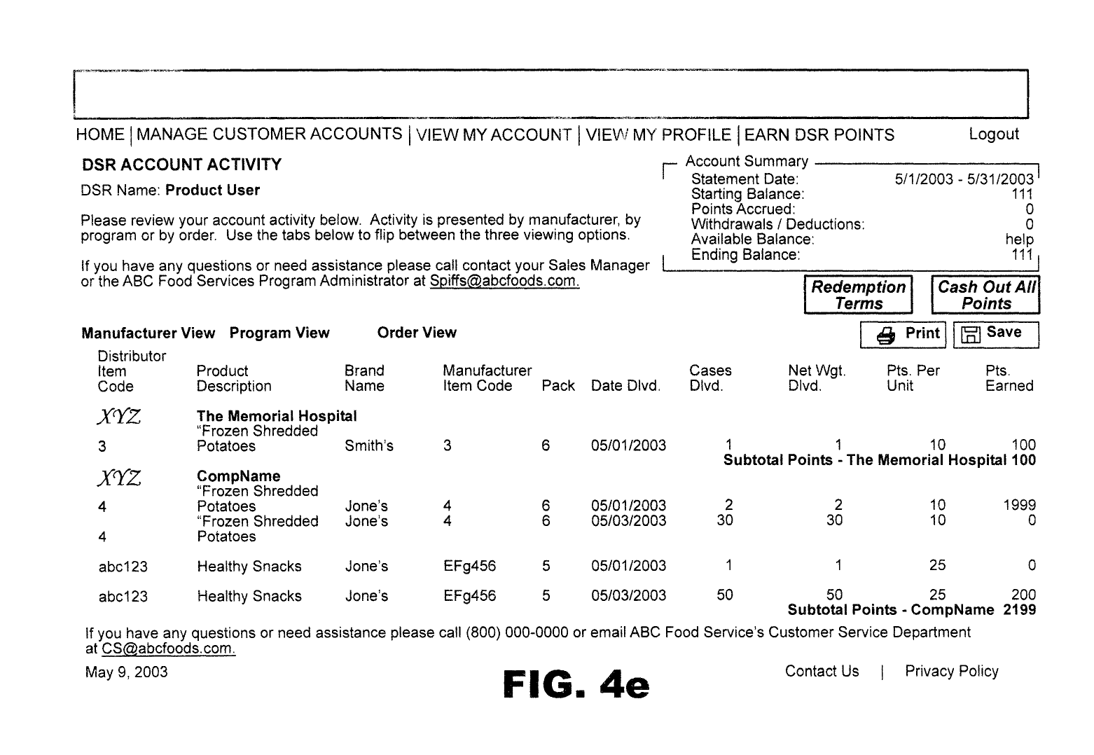

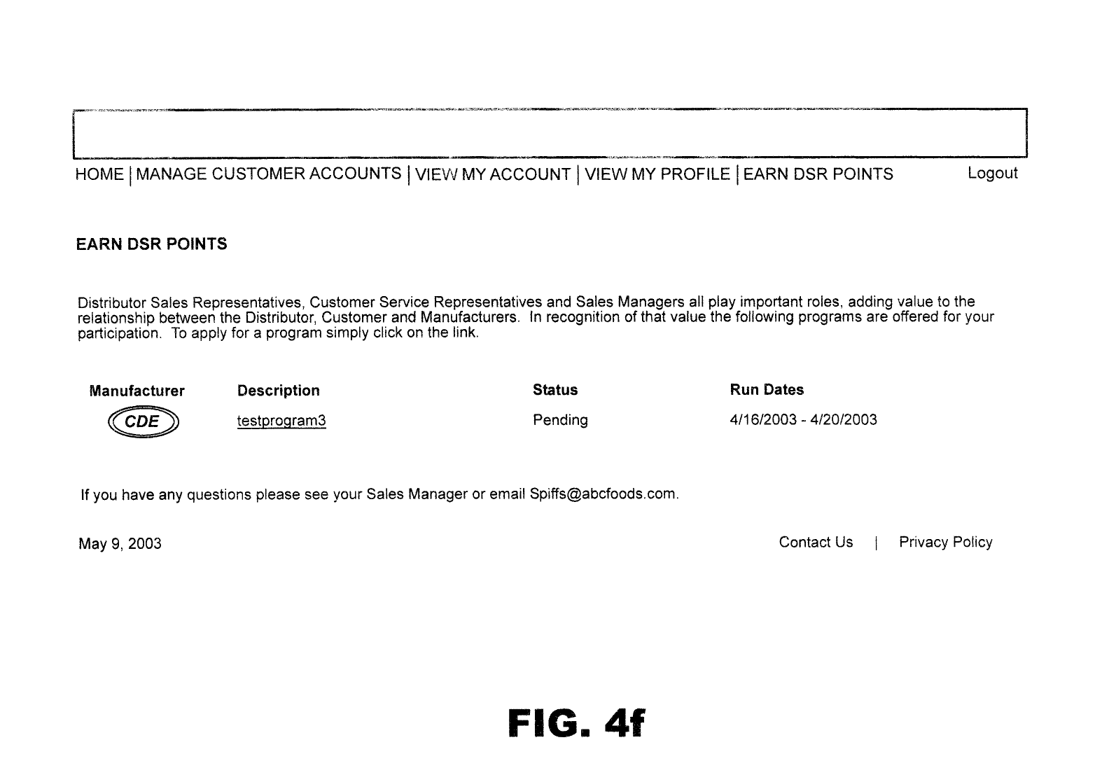

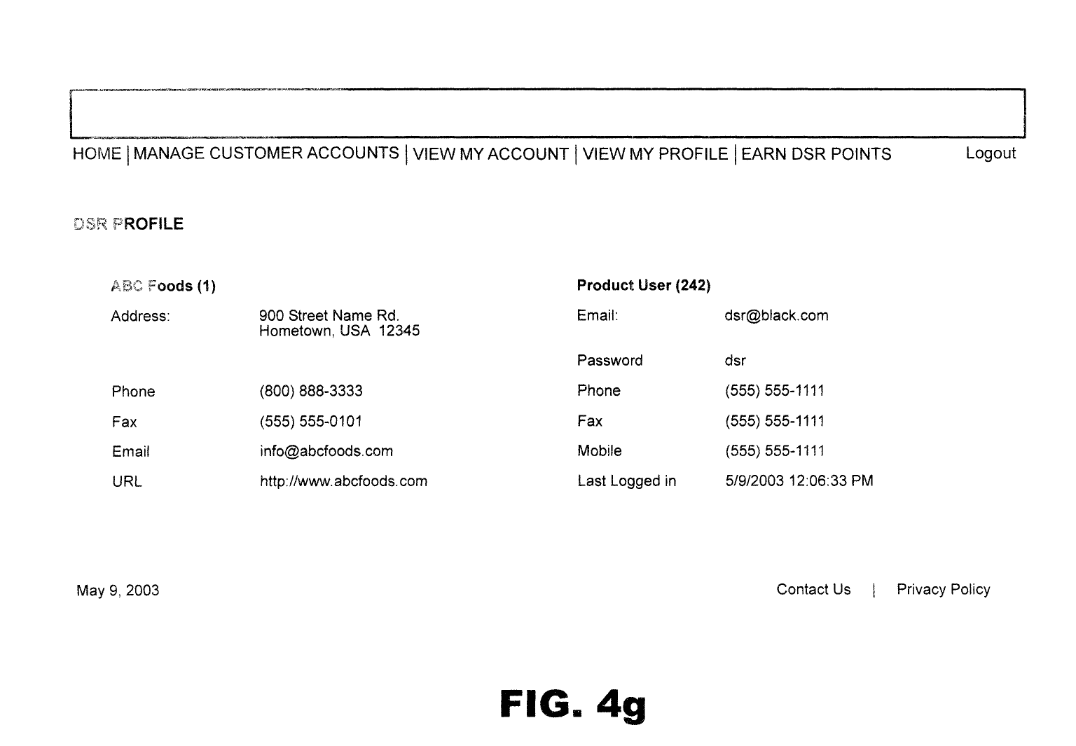

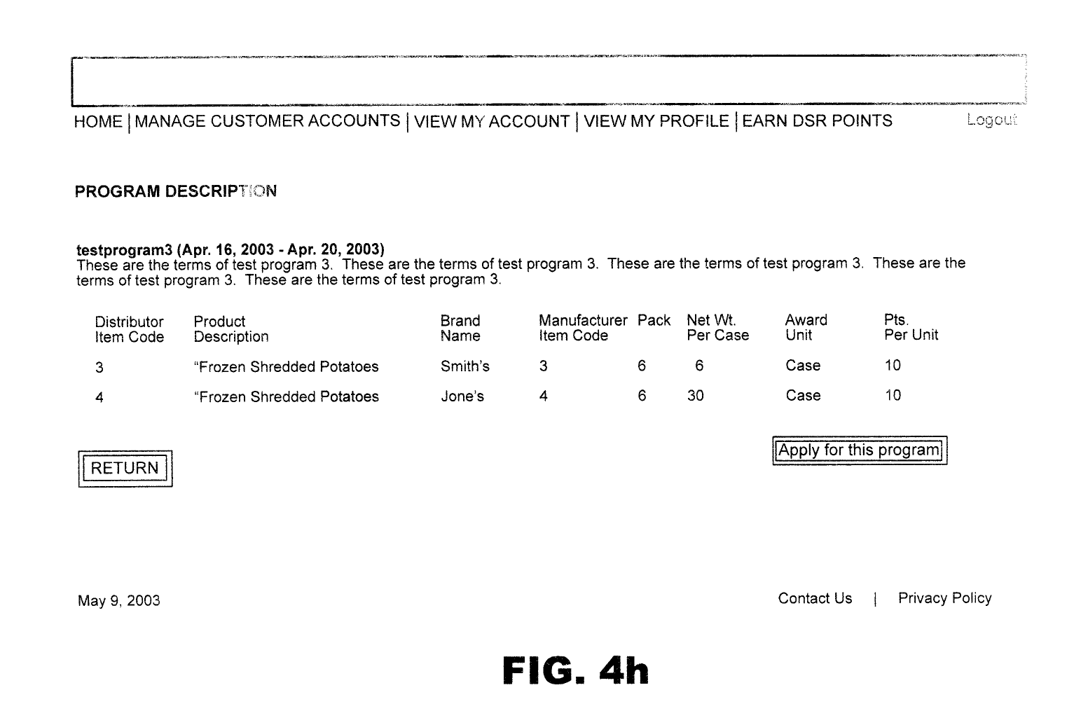

Referring now to FIG. 3a-3g and FIGS. 4a-4h respectively, examples of Distributor and DSR accessible interfaces are shown. Distributor Administrators and DSRs will reach the sign-in page, FIG. 1, using a unique independent URL assigned to the participating distributor by the Company. A link to this unique URL will be placed on the participating distributor's web site. By selecting/clicking on this link, the user will open a new browser window and be taken to the designated URL residing within the Company's web application. The URL and application will not normally reside within the URL or domain of the distributor. Distributors and DSRs will enter the application from a secure sign-in page using a Distributor Identifier (number) and password (both assigned by the Company). An alternative may provide for the Distributors or DSRs to sign-in using their email address 10, plus password 11. FIG. 1. The system will recognize the user's sign-in and allow access to the appropriate areas of the application as assigned by the Company. First time users will need to obtain their password from the associated Company administrator. Users not having email or web access will be set-up directly by the participating distributor just as if they were to use the website. When setting up such a customer, the distributor administrator will designate within the profile that the customer is to receive monthly printed statements.

Referring again to FIG. 3a, the distributor administrator's home page is the starting point from which a number of options may be selected. Generally, the top of each page may include a banner 21, that may be used for source identification or advertising purposes. Just below the aforementioned banner 21, are a series of operator selectable options. The selectable options include, but are not limited to, “Home”, “Customer Accounts”, “Customer Incentive Programs”, “Vendor Programs”, “Vendor Accounts”, “DSR Accounts”, “DSR Profiles”. For example, the “Customer Accounts” option can display a list of customers that are affiliated with the distributor and can allow the administrator to view purchase history of each customer. The “Customer Incentive Programs” option can display a list of programs that are targeted by the distributor to specific customers. The “Vendor Programs” option can display a list of vendor run rebate or incentive programs. The “DSR Accounts” and “DSR Profiles” options can display a list of DSRs that are registered with the distributor, along with specific sales performance information and reports.

In addition to the aforementioned options, various management options are also available on this page. One such selectable management option allows the operator to “Manage a User” 51. This option enables the operator to select a user type from a pull down menu 52. The selections on the pull down menu 52 may include various users such as Customer, Multiunit, DSR, Distamin, Broker, and Manufacturer. Additionally, the operator can enter a name, or number in the available window 53. Once the desired information is entered, the operator accesses the user management section by clicking/selecting the “Submit Query” button 54. The user management section/page is displayed as FIG. 3h. Referring now to FIG. 3h, the page includes a plurality of columns, having titles such as, “Company Name”, “Contact Name”, “User Type”, and “Active”. From this page, the operator may select from a list of companies, and access a page wherein the customer profile can be edited/viewed, as illustrated in FIGS. 3i and 3j.

Referring again to FIG. 3a, additional management selectable options may include “Create a New User” 55, Manage a Program” 56, and “Create a New Program” 57. Aptly named, these options may allow the distributor administrator to create or add a new user to the system, manage incentive programs, or create new incentive programs.

Additionally, by clicking on any of the options labeled 59-64 of FIG. 3a, the distributor administrator is forwarded to the associated pages respectively labeled as the FIGS. 3b-3f. Selecting one of these options, grants the distributor administrator the ability to access and manage the desired accounts, programs, and/or profiles.

Referring to FIGS. 4a-4h, the DSR home page FIG. 4a is the starting point from which the DSR/user may access a series of options. Generally, the top of each page may include a banner 21, that may be used for source identification or advertising purposes. Just below the aforementioned banner 21, are a number of operator selectable options. The selectable options include, but are not limited to, “Home” 65, “Manage Customer Accounts” 66, “View My Account” 67, “View My Profile” 68, “Earn DSR Points” 69.

In addition to the aforementioned options, various management tools/options are accessible from this page. By accessing/selecting the Customer option 70, the operator may view either a specific customer account, or a list of all customer accounts. An additional management option allows the operator to view various DSR Programs 71. Furthermore, the DSR home page displays an “Account Summary” 72, further comprising a “Cash-out All Points” button 73, and “Redemption Term” button 74. Upon choosing to “Cash-out” option, the user accesses the page illustrated in FIG. 4b. The page provides a display indicating the number of points the operator may wish to redeem, as well as the options to confirm 76 or cancel 77.

Additionally, by selecting/clicking on the options labeled 66-69 of FIG. 4a, the DSR is forwarded to the associated pages. Selecting one of these options allows the distributor administrator to access and manage the desired accounts, programs, and/or profiles.

Referring now to FIG. 4c, the Manage Customer Accounts page is shown. The page consists of three columns, referred to as Customer Name, Customer Number, and Primary Contact. The operator may manage the customer account by selecting the desired customer from the Customer Name column. Upon selecting the name of the customer the operator will access a page similar to FIG. 4d. Referring now to FIG. 4d, the programs in which the customer is presently enrolled, are displayed. The page further provides Manufacturer Name, Description of Program, Status of Program, and Run Dates of the program.

The DSR may access information on his own account by selecting the “View My Account” option 67. Upon selection of this is option the DSR Account Activity page is displayed FIG. 4e. The page allows the operator to view account activity from either a manufacturer view, a program view, or an order view. FIG. 4e as illustrated, provide a manufacturer view. The columns include the Distributor Item Code, Product Description, brand Name, Manufacturer Item Code, Pack, Date Delivered, Cases Delivered, Net Weight Delivered, Points per Unit, and Points Earned. Generally, a subtotal of points will appear in each customers respective section.

Referring now to FIG. 4g, the DSR profile page is shown. The DSR Profile page is accessible by selecting the View My Profile option 68, and may contain DSR information as displayed.

Referring now to FIG. 4f the Earn DSR Points page is shown. This page is accessible by selecting the Earn DSR Points option 69, and provides information of various incentive programs. The page may include a number of columns listing Manufacturer, Description, Status, and Run Dates. By selecting/clicking on a particular description, the operator accesses the Program Description page associated with the selected program FIG. 4h.

Referring to FIG. 4h, the Program Description page is shown. The Program Description page may comprise a listing of available programs, as well as their terms. The Program Description page further comprises an array of columns identifying Distributor Item Code, Product Description, Brand Name, Manufacturer Item Code, Pack, Net Wt. Per Case, Award Unit, and Points Per Unit. Additionally, a selectable button on the Program Description page, aptly named “Apply for this program” allows the operator to request participation in a program.

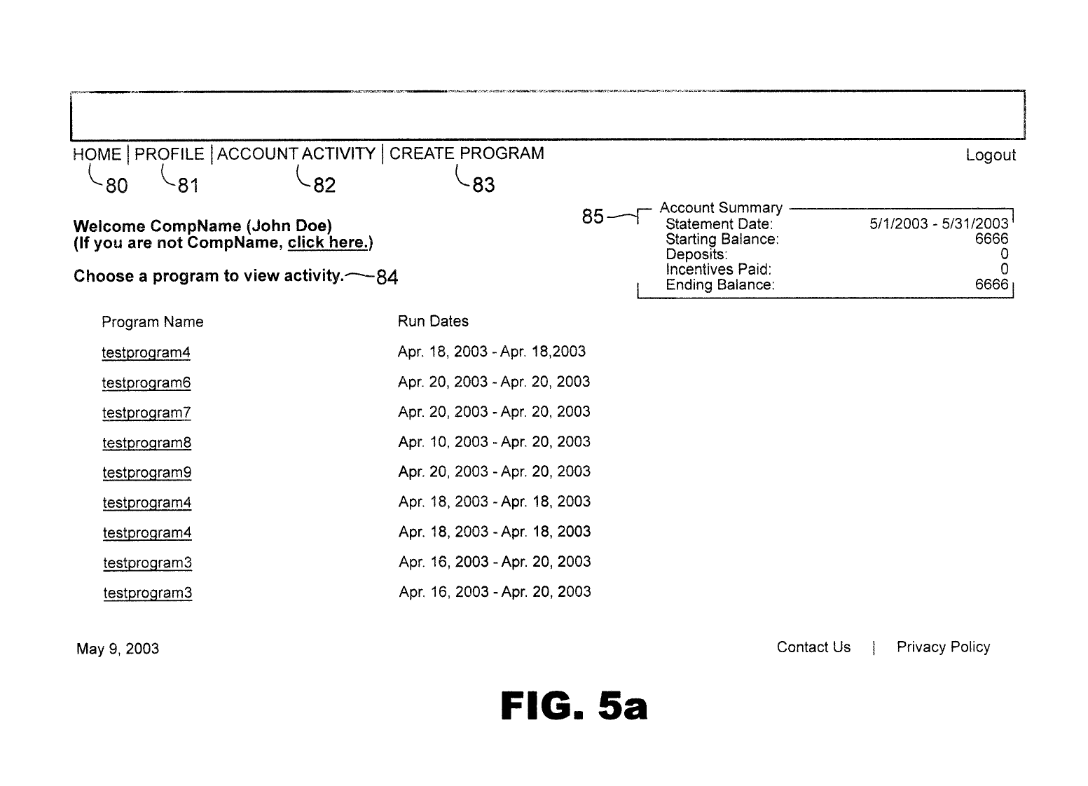

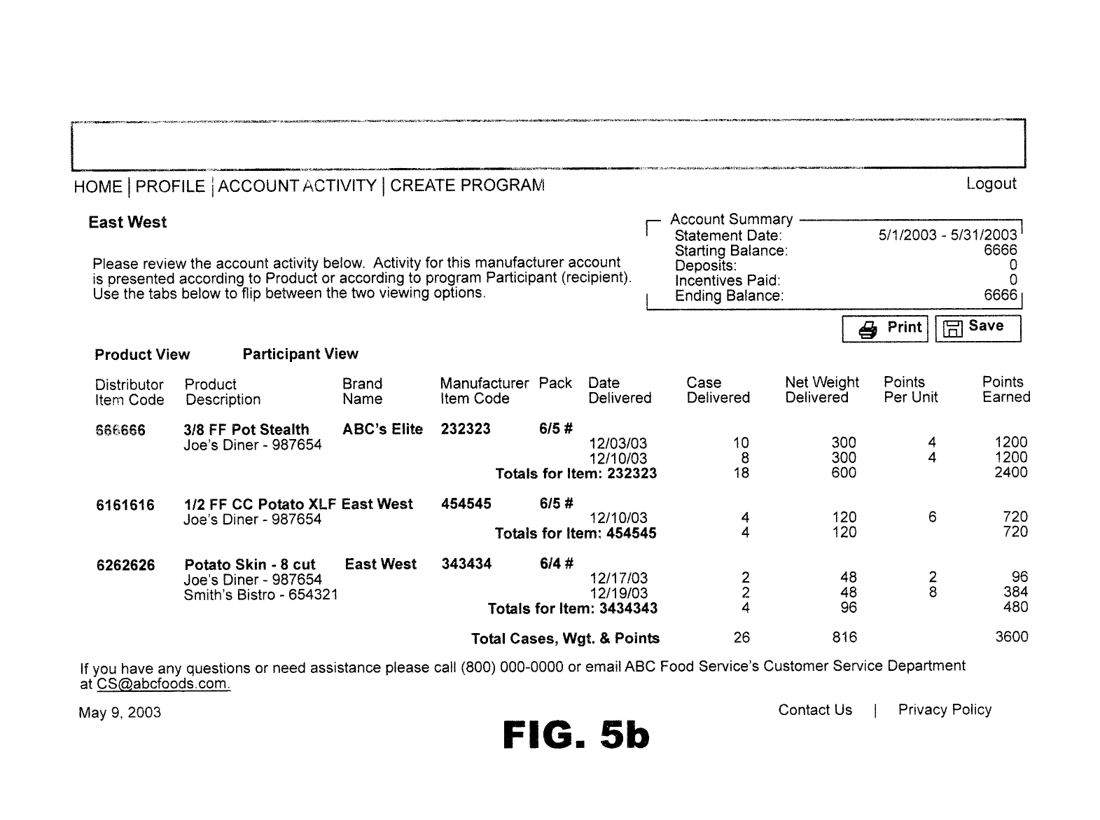

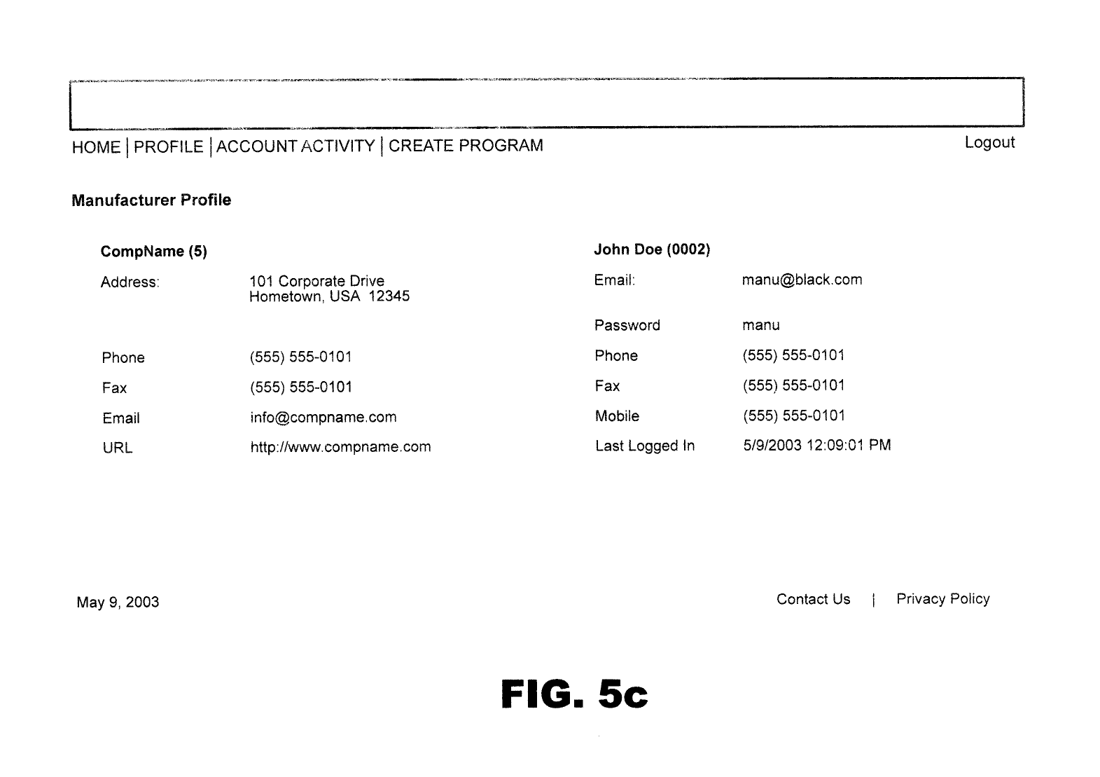

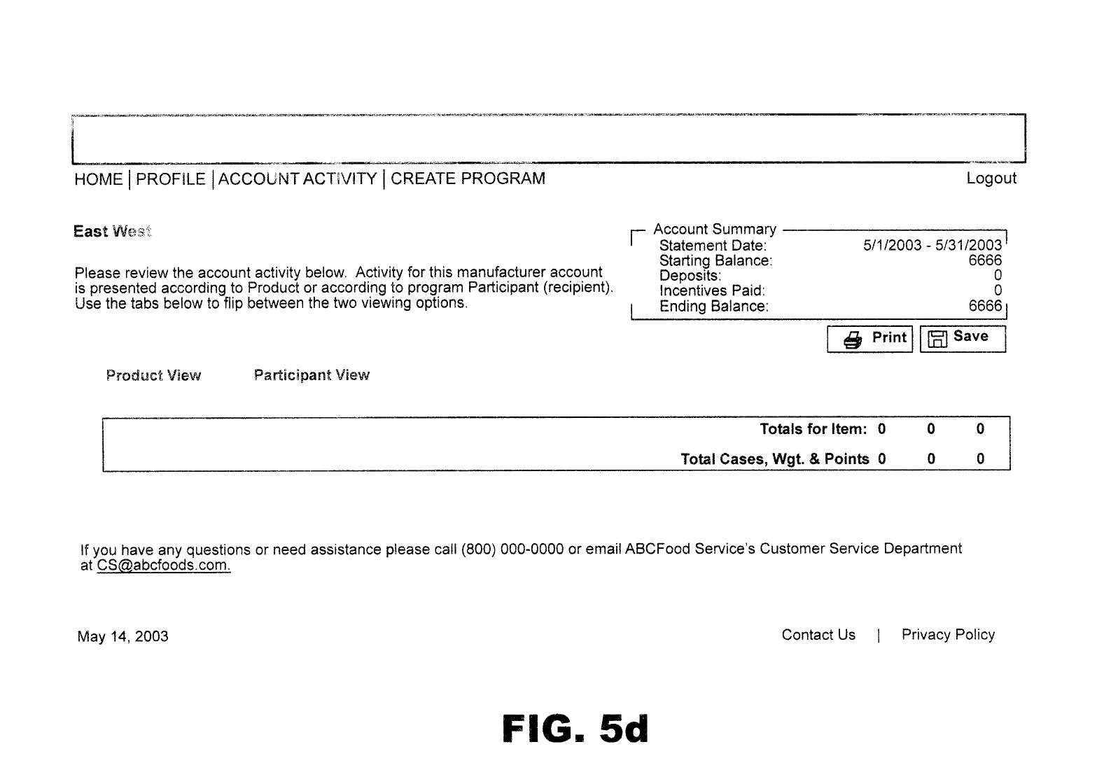

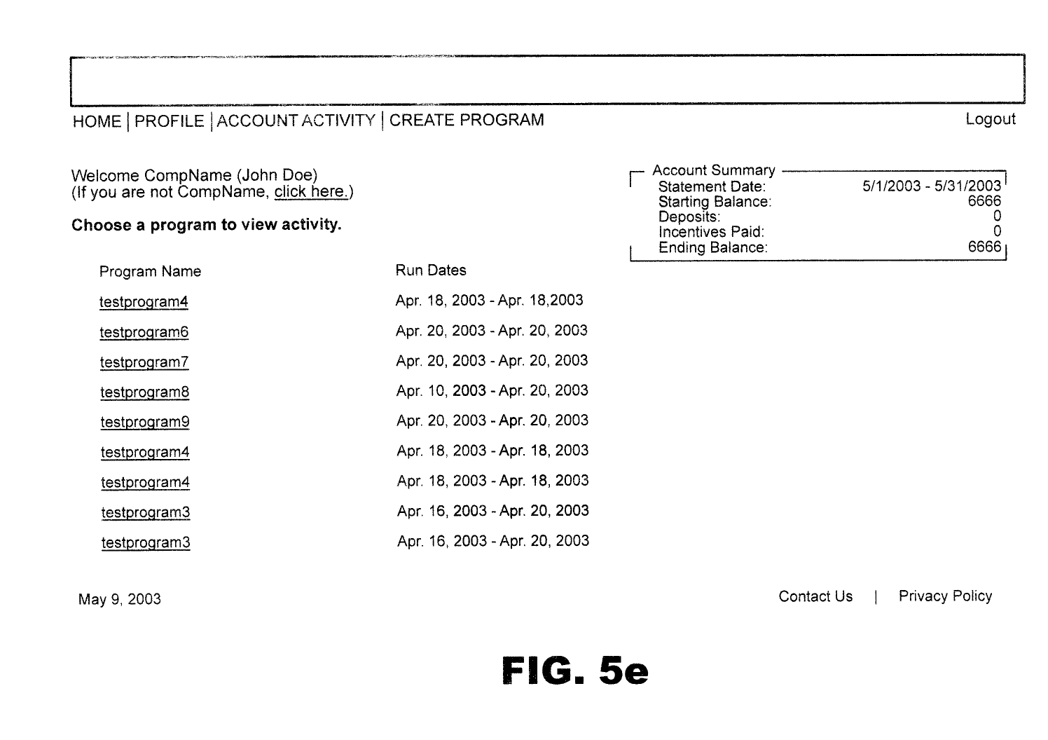

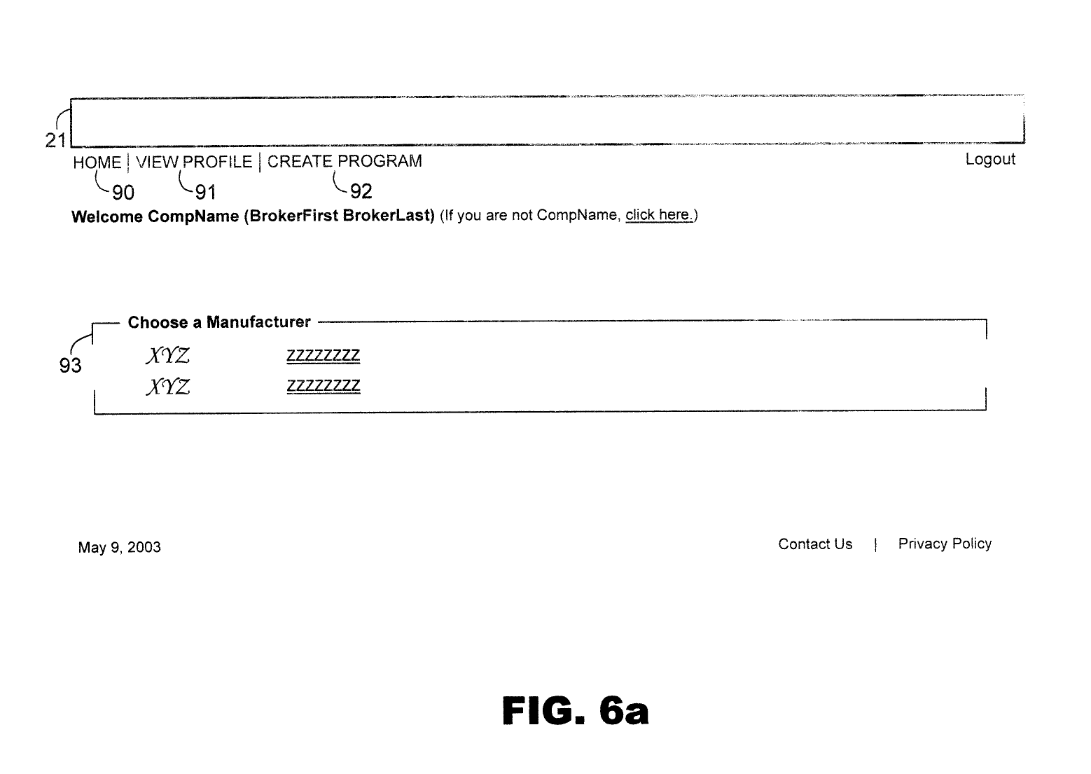

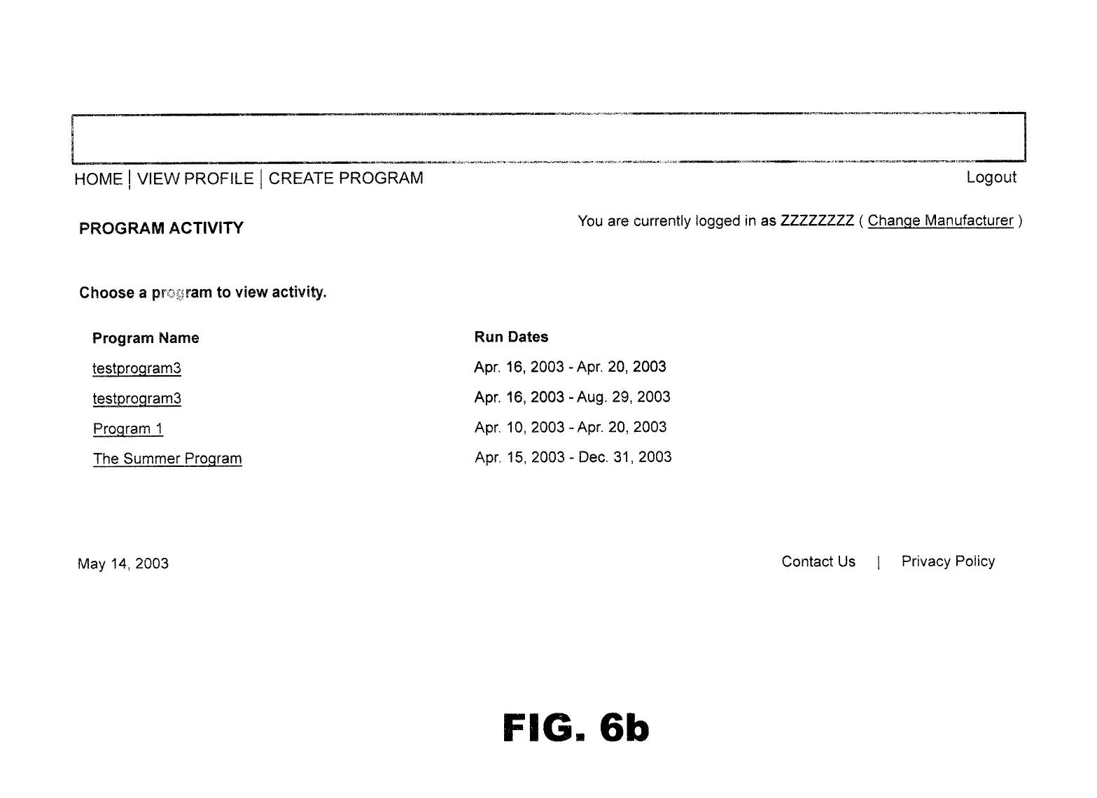

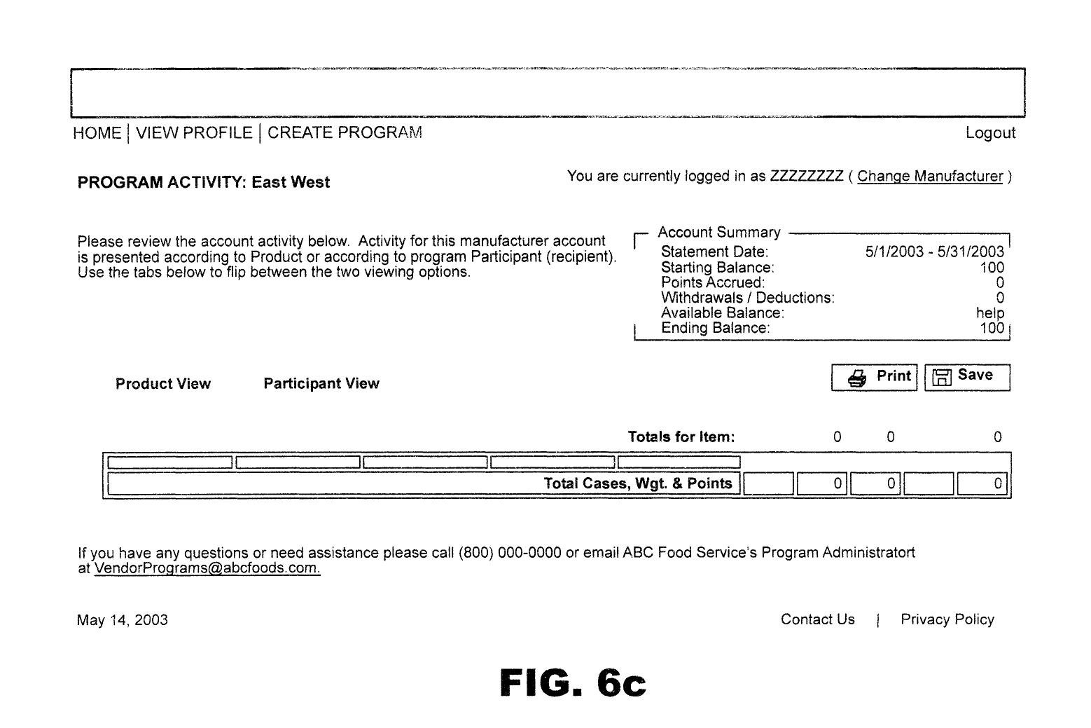

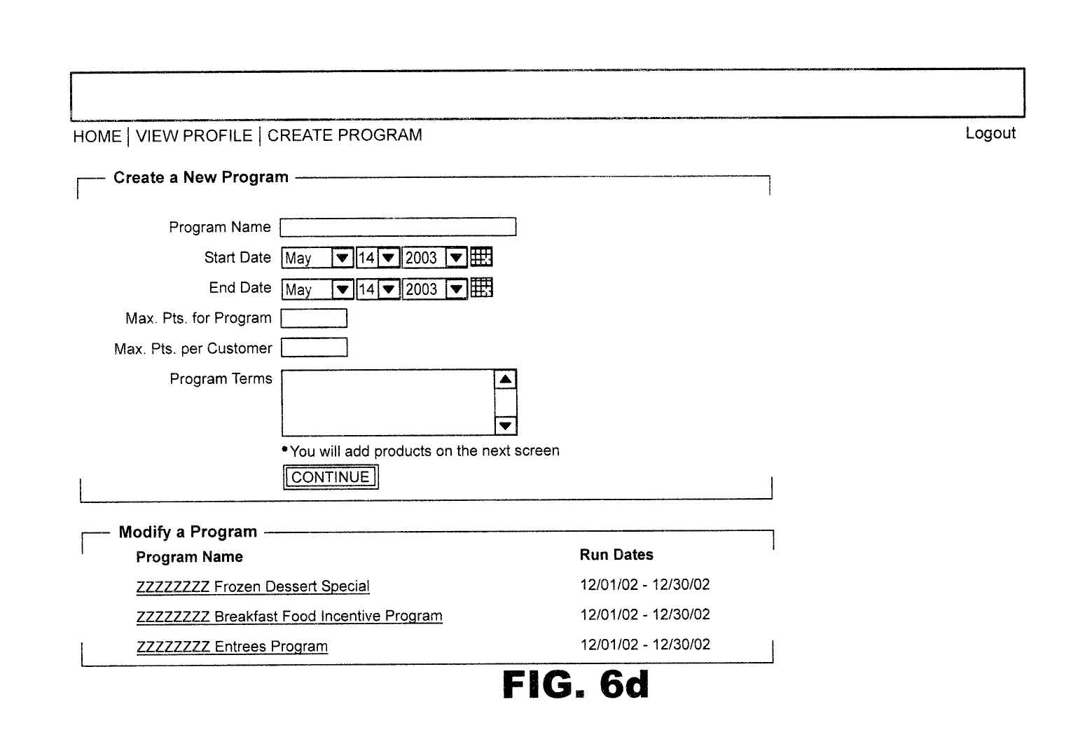

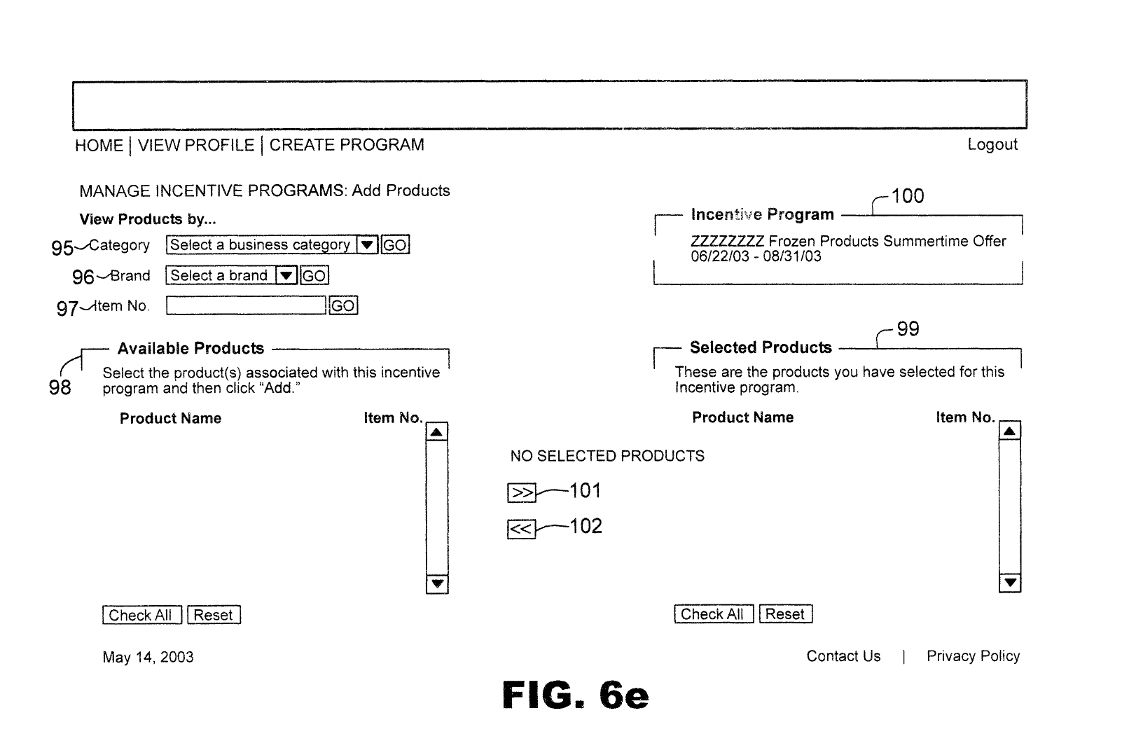

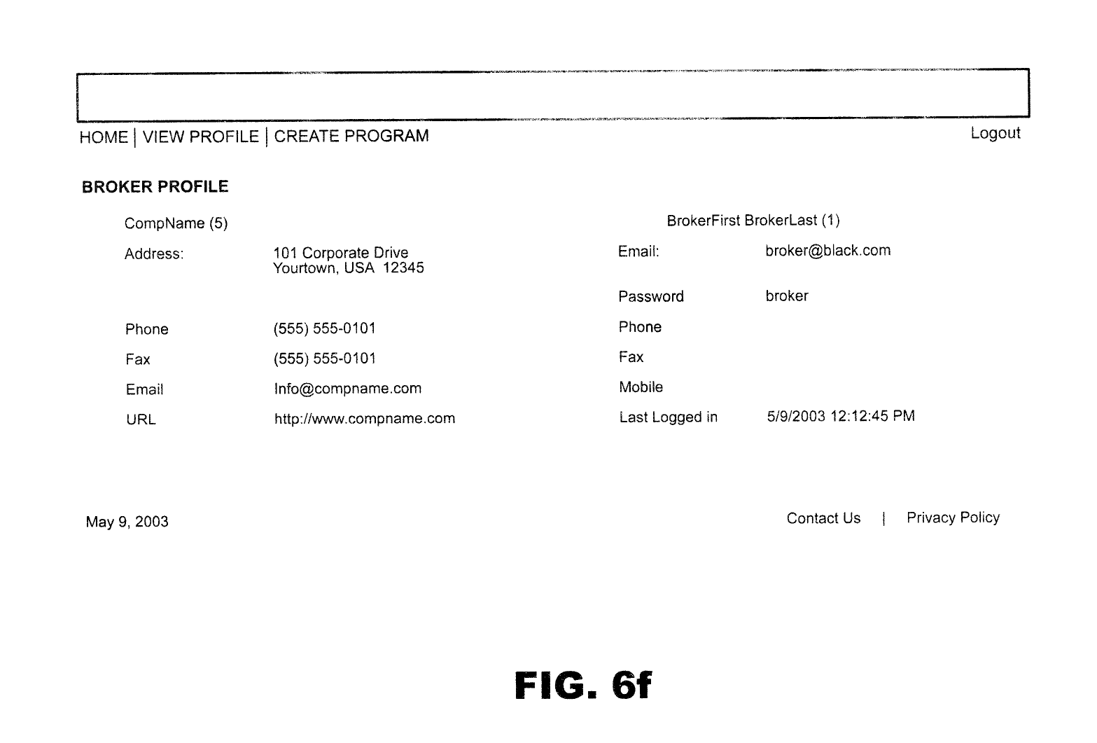

Referring now to FIGS. 5a-5e and FIGS. 6a-6e respectively, the Manufacturer and Broker interfaces are shown. Manufacturers and Brokers may reach the sign-in page FIG. 1 using a specific independent URL assigned to the participating distributor by the Company. A link to this unique URL will be placed on the participating distributor's web site. By clicking/selecting this link the user will open a new browser window and be taken to the designated URL residing within the Company's web application. The URL and application will not normally reside within the URL or domain of the distributor. Manufacturers and Brokers will enter the application from a secure sign-in page using a Identifier (number) and password (both assigned by the Company). An alternative may provide for the Manufacturers and Brokers to sign-in using their email address 10, plus password 11. FIG. 1. The system will recognize the user's sign-in and allow access to the appropriate areas of the application as assigned by the Company.

The present invention allows the vendor to view and select products from a list of products stocked by a participating distributor, wherein said product list is defined and controlled by the distributor. Furthermore, this interface will permit the manufacturer to view and administer their specific accounts associated with each distributor.

Referring now to FIG. 5a, the Manufacturer home page is the starting point from which he may access a series of options. Generally, the top of each page may include a banner 21, that may be used for source identification or advertising purposes. Just below the aforementioned banner 21, are a number of operator selectable options. The selectable options include, but are not limited to, “Home” 80, “Profile” 81, “Account Activity” 82, “and “Create Program” 83.

In addition to the aforementioned options, various management options are also accessible from this page. The “Choose a program to view activity” option 84, allows the operator/manufacturer to select from a list of available programs and monitor activity. Additionally, the Manufacturer home page displays an “Account Summary” 85, identifying “Statement Date”, “Starting Balance”, Deposits”, “Incentives Paid”, and “Ending Balance”.

Referring now to FIG. 5b, an Account Activity page is illustrated. The user is able to monitor all of the activity for a particular manufacturer via either a product view, or a participant/recipient view. The Account Activity page further comprises an array of columns identifying Distributor Item Code, Product Description, Brand Name, Manufacturer Item Code, Pack, Date Delivered, Case Delivered, Net Wt. Delivered, Points Per Unit, and Points Earned. Furthermore, a total is provided for each product or participant group below selected groups, particularly the Case Delivered, Net Wt. Delivered, Points Per Unit, and Points Earned groups. Additionally, as illustrated on the home page FIG. 5a, the Activity Page FIG. 5b also displays the account summary.

Referring now to FIG. 6a, the Broker home page is shown. Generally, the top of each page may include a banner 21, that may be used for source identification or advertising purposes. Just below the aforementioned banner 21, are a number of operator selectable options. The selectable options include, but are not limited to, “Home” 90, “View Profile” 91, and “Create Program” 92.

Additionally, various management options/tools are accessible from this page. One such option (Choose a Manufacturer) 93 allows the operator/manufacturer to select from a list of manufactures, and view programs offered by the specific manufactures. The accessible information may include Program Names and Run Dates (see FIG. 6b). By selecting a particular program from the Program Name column illustrated in FIG. 6b, the operator accesses Program Activity information as displayed in FIG. 6c. Referring again to FIG. 6b, the Program Activity information may include an Account Summary, and an option allowing the operator to choose between Product View or Participant View of program activity

Referring again to FIG. 6a, selecting the Create Program option 92 grants the user access to a series of tools, thereby enabling the user to create new incentive programs FIG. 6d. The Create a Program interface further provides the operator/broker a means for creating a program name, defining program start date and end date, defining the maximum points for the program, maximum points per customer, and program terms. Upon entry of the above information, the operator may begin to manage the incentive program via the Manage Incentive Program page FIG. 6e.

Referring now to FIG. 6e, the Manage Incentive Program page is shown. The operator may view selected products by either category 95, brand 96, or Item Number 97. Additionally the page displays a list of Available Products 98 associated with the incentive program and a list of Selected Products 99. Products can be moved between the two lists by highlighting the desired item, and clicking the appropriate add/remove button 101 102. Additionally the page includes an area identifying the selected Incentive Program 100, including the program name and run dates. Referring now to FIG. 6f, the broker profile is shown. This profile contains various information on the broker as illustrated.

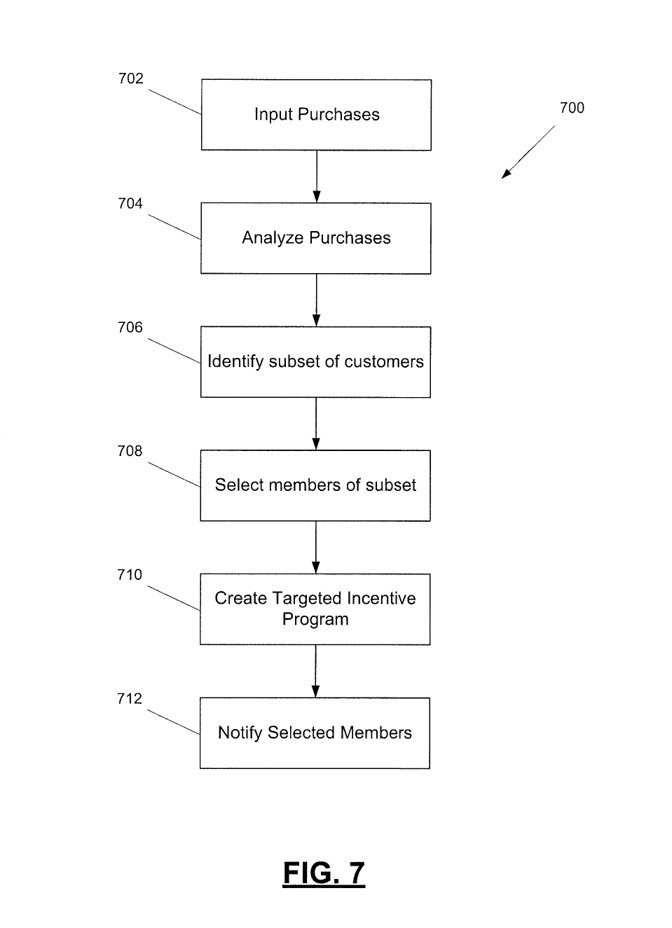

Referring now to FIG. 7, a method 700 is initiated when the purchase data of at least one food service customer is entered into a database in step 702. This data is entered in such a fashion that a historical record of purchases can be analyzed for certain patterns. Such entered data may include, for example, the identity of the customer(s), the identity of the food item(s), the identity of the manufacturer of the food item(s), the purchase price, the purchase date, and the like. Once historical data concerning such purchases has been entered into the database, this data may be accessed, analyzed, and reported upon.

In step 704, the database is accessed using an internet-based interface, such as a webpage, and analyzed according to certain criteria. Advantageously, this permits the individual who performs the analysis to construct a “void matrix” that identifies areas for potential marketing activity. A query of the database can be constructed in step 704 for those food service customers who have ordered a first product, but who failed to order a second product. By way of an example and in many regions, it is traditional to serve certain chicken wings with blue cheese dressing. Using this example of linked items and in step 704, the database can be analyzed to identify foodservice customers who have a current inventory of chicken wings, but who have not recently ordered blue cheese dressing. Since the data analysis of step 704 queries the real-time data as it is being entered in step 702, the analysis uses the most up-to-date data available. It will be readily understood that a myriad of other suitable examples can be readily identified wherein similar queries can be made.

In step 708, at least one member of the identified subset to selected to participate in the targeted incentive program. In one embodiment, all of the members of the subset are so selected. Such a selection may be automated or may be manually performed. For example, the user of the internet-based interface may know that a first customer never serves blue cheese dressing at their establishment. The user can choose to not select this customer for participation in the targeted incentive program.

In step 710, the user creates the targeted incentive program on the host computer to correspond to the purchasing history of the selected subset of customers. For example, the targeted incentive program may offer a ten dollar discount on the purchase of the next two cases of blue cheese dressing if purchased within the next two days. As described elsewhere in this specification, alternative incentive programs can also be designed. For example, a fixed discount per unit weight can be offered. Alternatively, points can be accumulated toward a prize (e.g., a free trip). In step 712, the selected members of the subset of foodservice customers are notified, preferably over the internet using the host computer, that they now qualify for the targeted incentive program. Referring to a prior example, the selected customers may received an e-mail notifying them that they qualify for a ten dollar discount on blue cheese dressing if purchased within the next two days. Those customers who were not selected do not receive the notification and are therefore not eligible to participate in the targeted incentive program. In this fashion, a target incentive program can be created and distributed that is both specific to a given product and customized for a particular customer or a select group of customers.

Such targeted programs are useful for moving excess inventory. For example, in the event that excess inventory of a perishable item needs to be sold, a targeted incentive program can be created and distributed to those customers most likely to utilize such a program. The program can be created such that the next X units of item Y will be discounted or otherwise provide a benefit to the purchaser. In this manner the surplus X units can be liquidated and inventory can be restored to its desired quantity.

Foodservice vendors, foodservice customers and foodservice distributors all visit the same website to access the distributor's data, although each is provided with different screens as described elsewhere in this specification. Master accounts may be established on a per-distributor basis. For example, the database may be hosted at a given website and each distributor creates a sub-site that is specific to their distribution line. By way of illustration, if the host computer had an URL of www.host.com, then distributor XYZ may be assigned an address of XYZ.host.com. Distributors typically pay a subscription fee for continued access to the service and thus, are able to establish the rule set for the presentation of their pages. In this fashion, distributors can present customized catalogs of available products to the users as well as offer other incentive programs, in addition to targeted incentive programs. Generally, only the distributor pays a subscription fee. The foodservice customers and vendors establish free log-in accounts with the purchase data being entered by the vendor. The customers establish accounts to receive real-time notification of the targeted incentive program. The incentive programs can be created by either the distributor or the vendor, although each party bears the financial burden of financing the programs it creates.

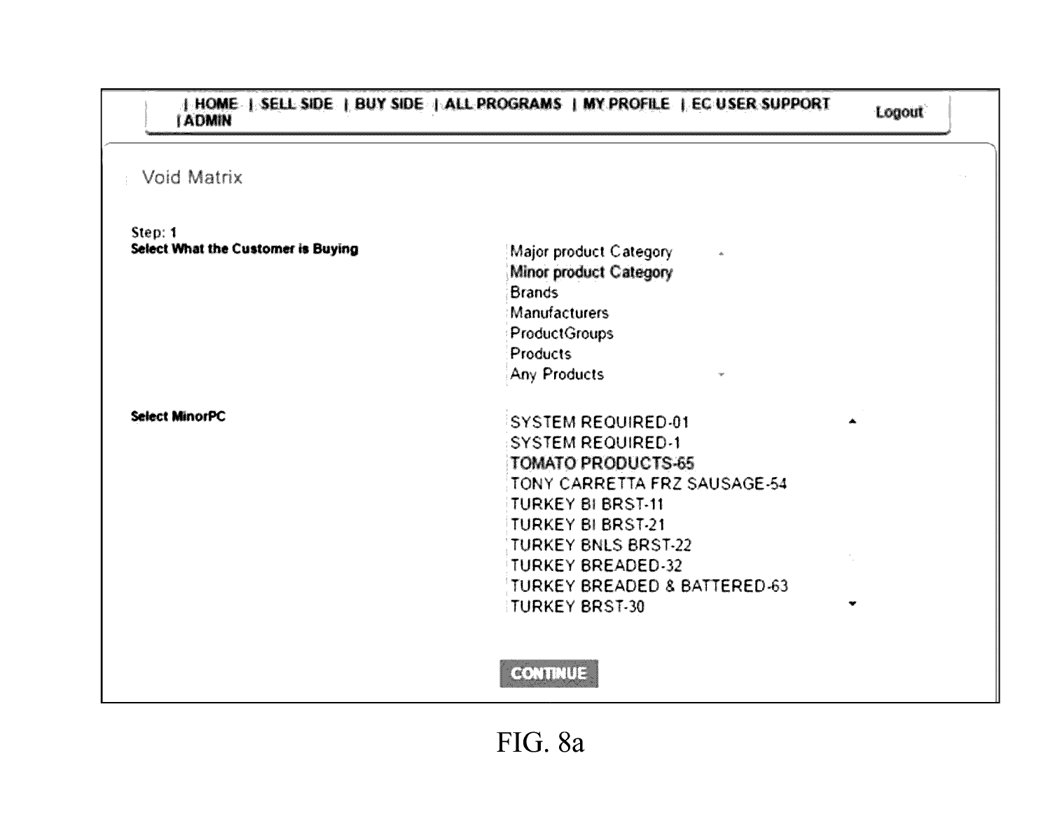

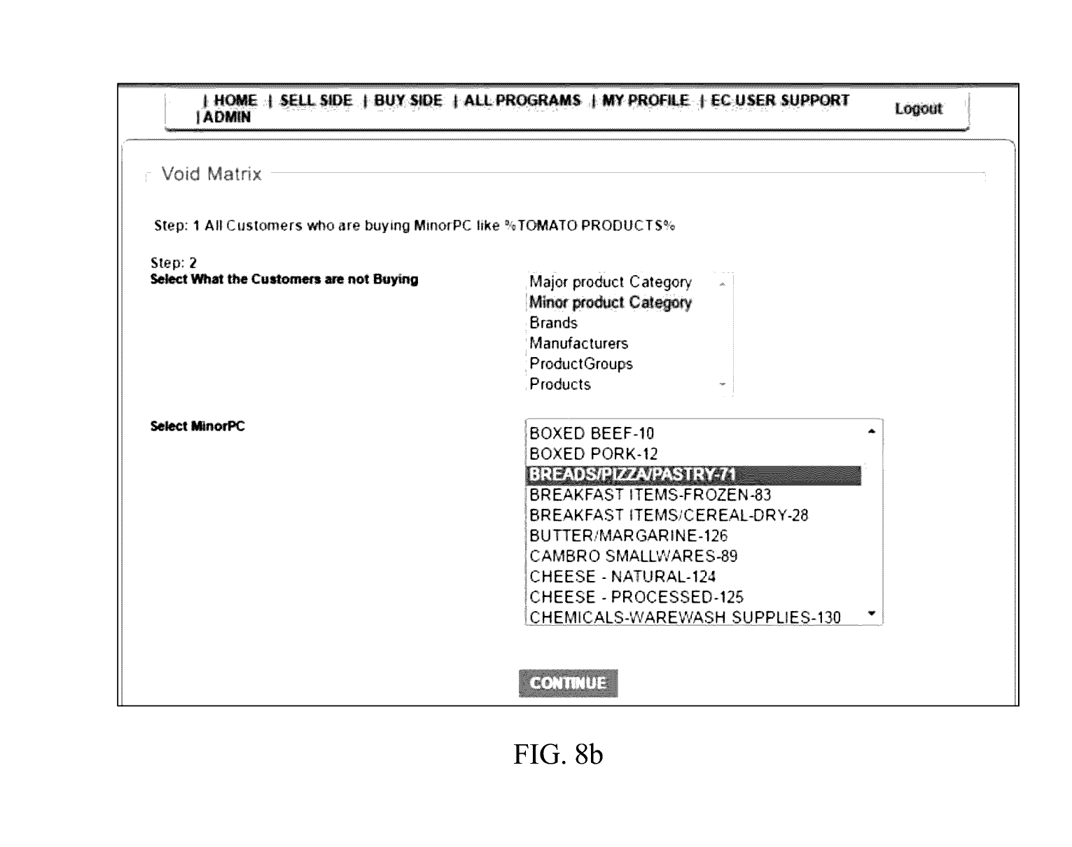

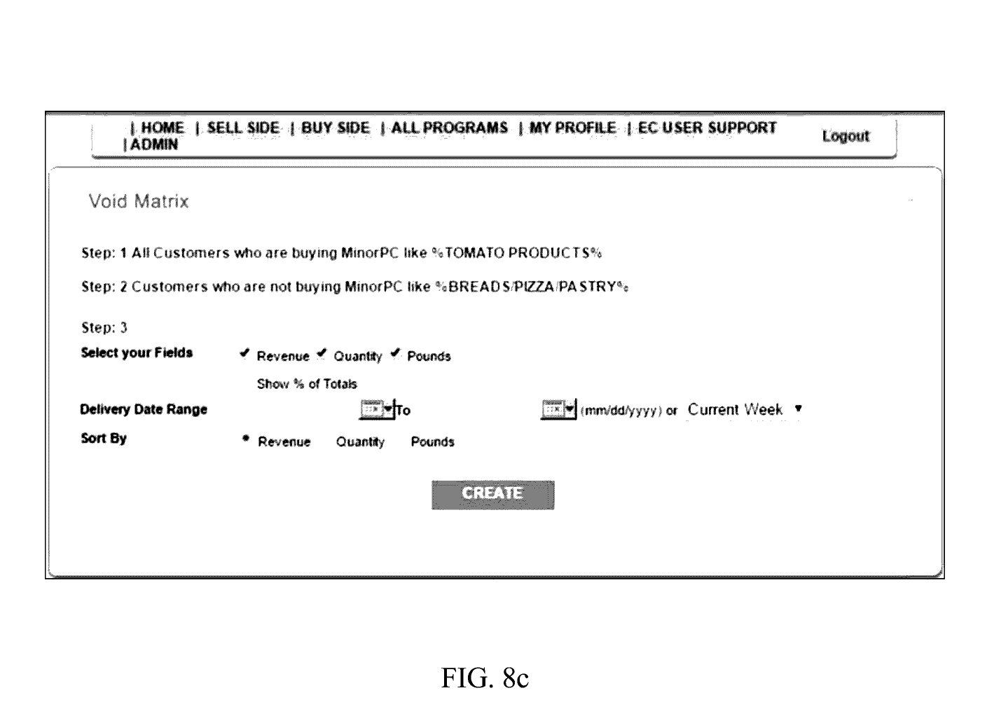

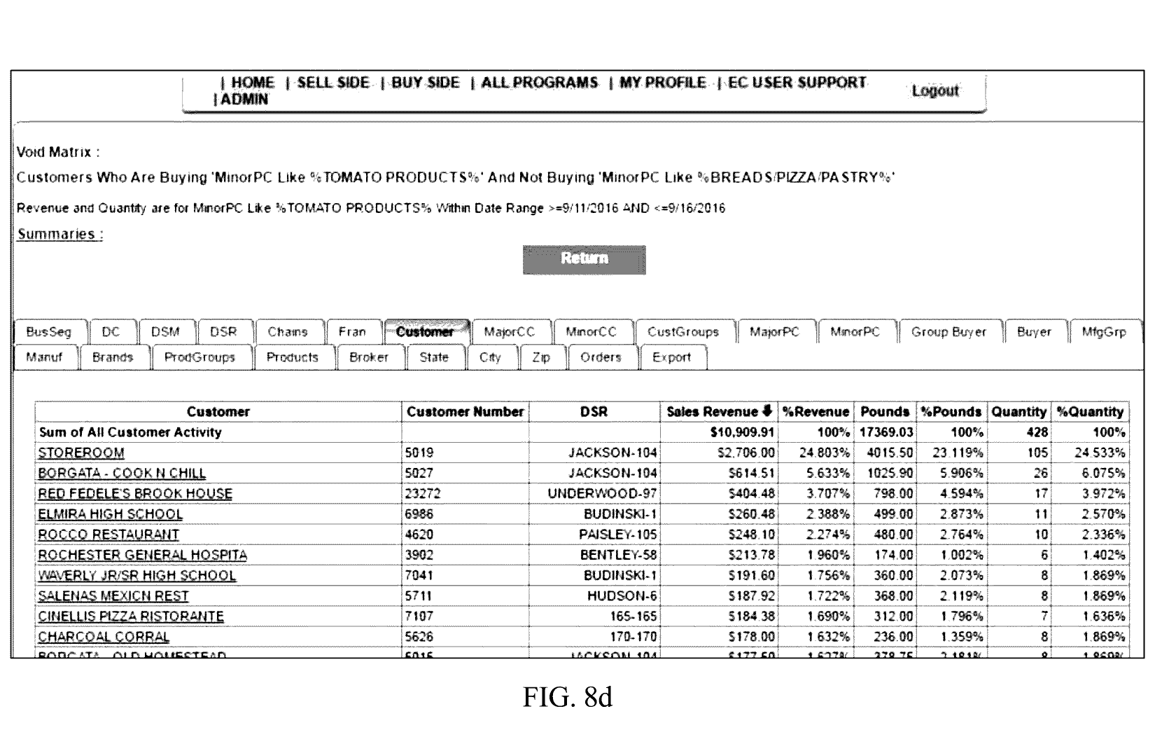

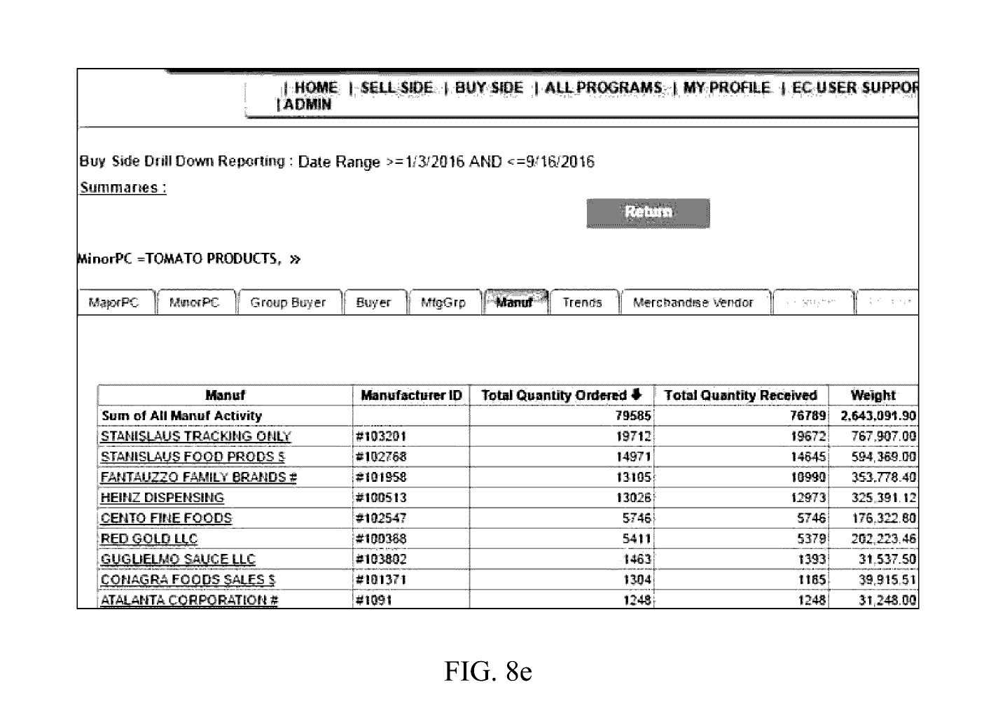

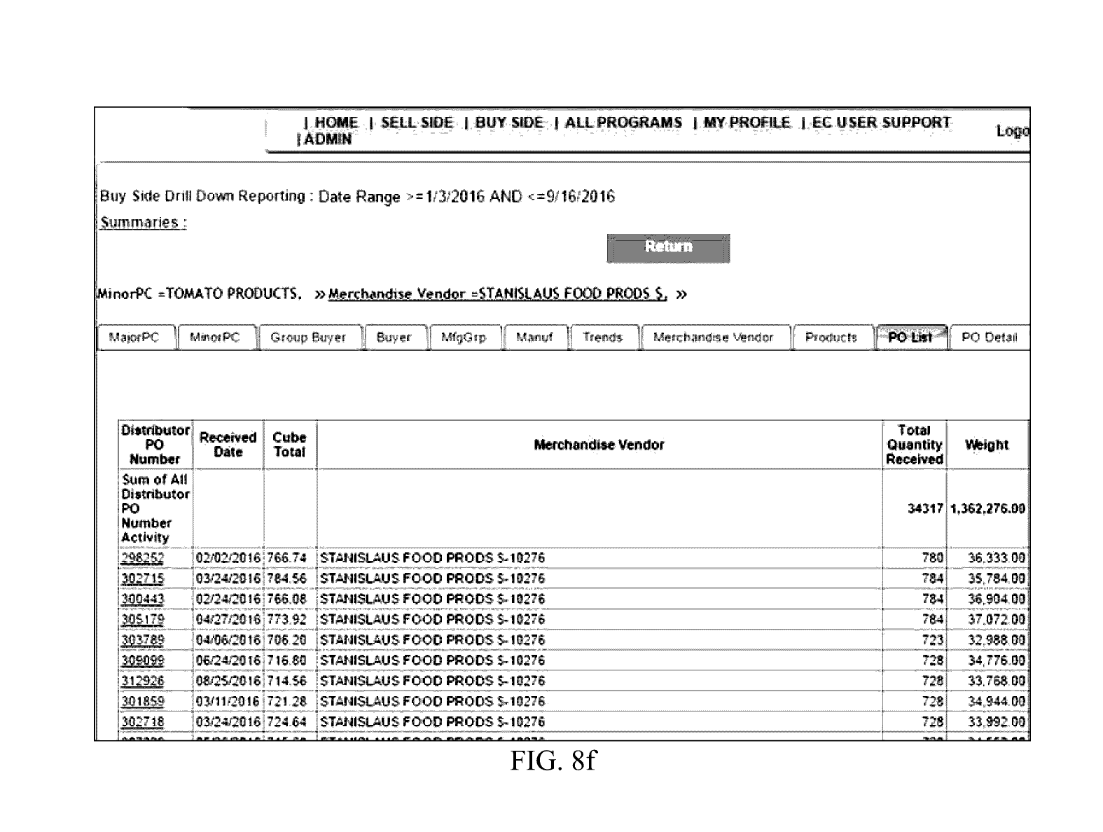

Referring now to FIGS. 8a-8f, a series of exemplary user interfaces demonstrate how a single set of supply chain data may be used by different users having different roles to achieve different goals. By way of explanation, a centralized supply chain database may provide access to users from different distributors, customers, vendors, and trade organizations. Through data segmentation, the supply chain database will only provide access to specific views of specific data that are appropriate for the different users.

Initially, the user interfaces of FIGS. 8a-8d may be used by a distributor to mine the supply to chain data to create targeted sales promotions. For example, the database may find so called “void matrixes” that indicate that a customer is not purchasing logically related products from the same distributor. The user interface of FIG. 8a allows a distributor to start by selecting a product that is being purchased various customers, for example tomato products. Next, the user interfaces of FIGS. 8b-8c allows the distributor to select a logically related product that is not being purchased by some customers, such as bread products. The user interface of FIG. 8d displays the result set, called a “void matrix” which is a list of customers that are purchasing tomato products but are not purchasing bread product.

As depicted in FIG. 8e, a customer may use the same supply chain data to view all tomato products purchased by that customer from all distributors, for example to compare prices. As depicted in FIG. 8f, a vendor may use the same supply chain data to view all of its products that have been purchased by different customers, for example to prepare rebates.

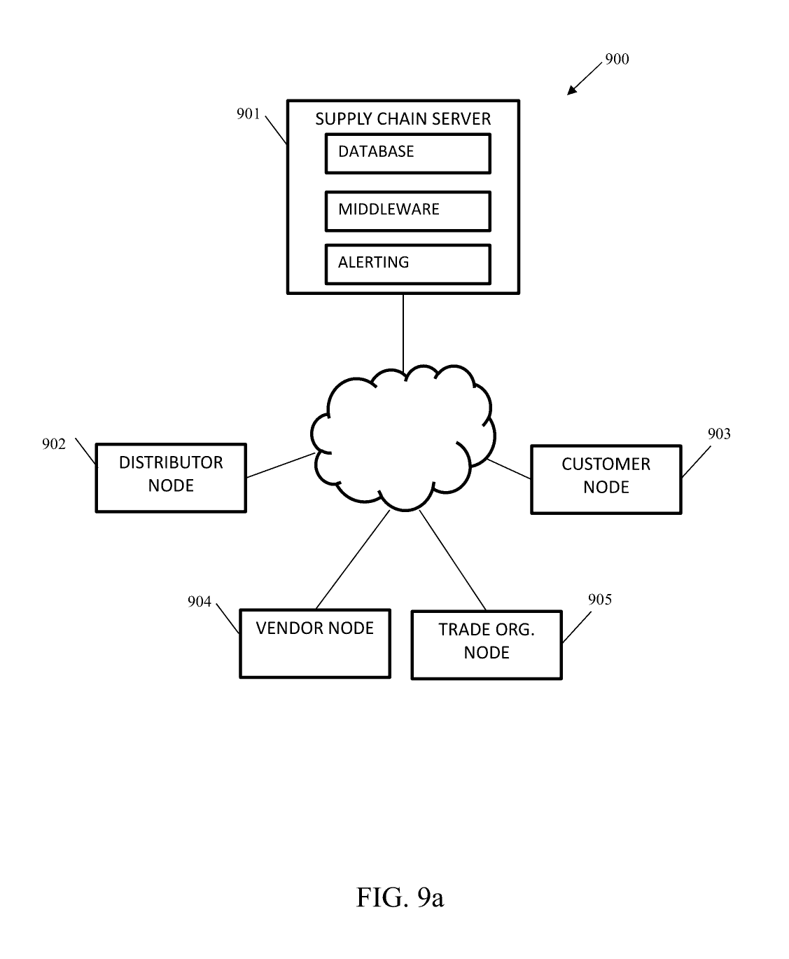

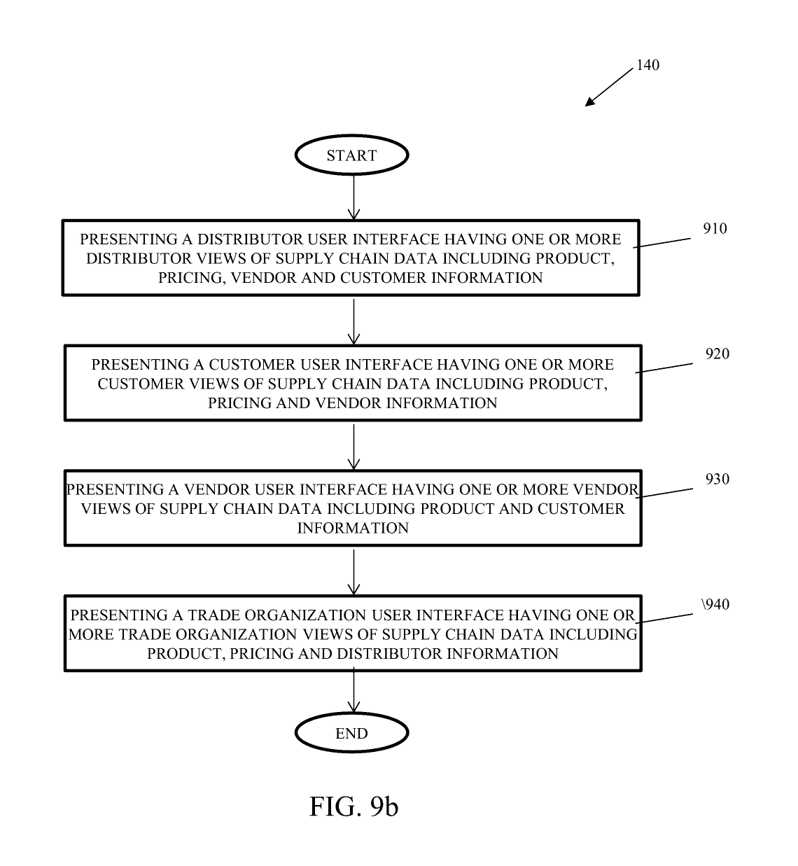

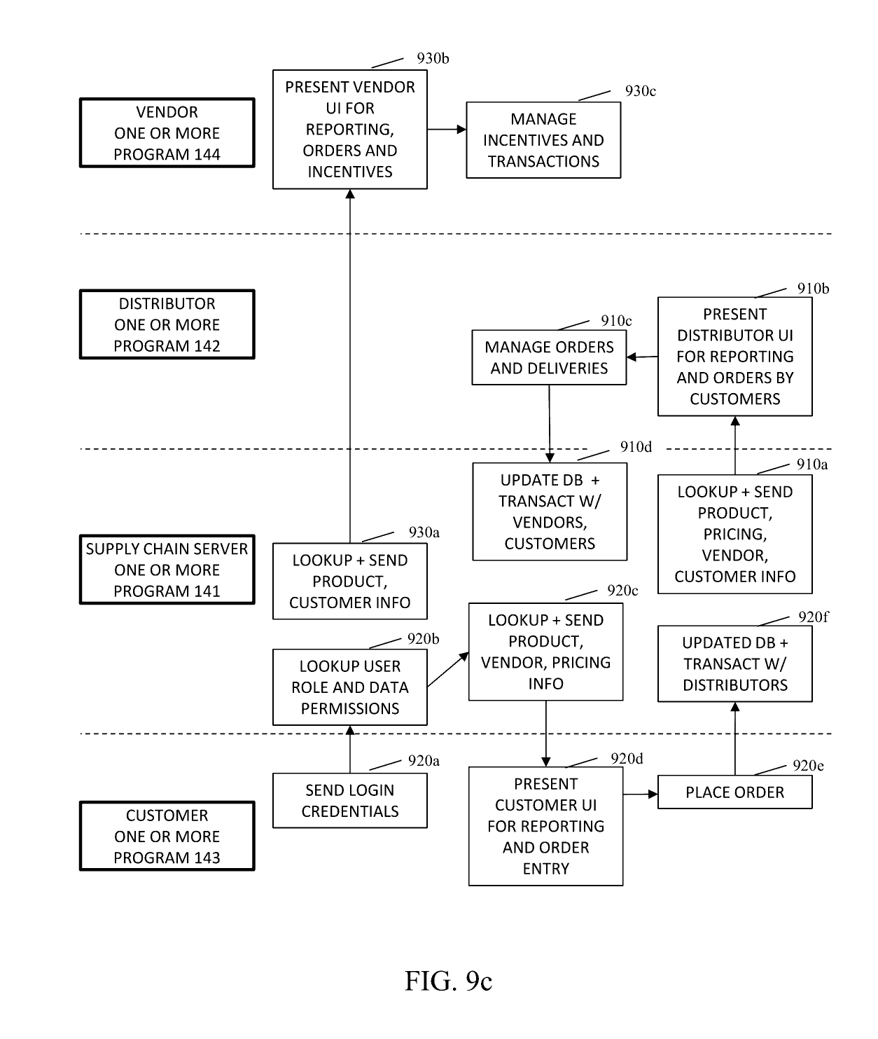

FIGS. 9a-9c depict further examples in which multiple different users having multiple different roles may form a supply chain ecosystem. By way of explanation, a supply chain ecosystem include different participants such as distributors, vendors, trade organizations and customers. Customers may be restaurants, schools, or other entities that need to receive various products in a multilevel supply chain. Vendors may be manufacturers or producers of one or more products, such as paper products, produce, tomato products, etc. Distributors are entities that work with multiple vendors to supply the needs of multiple customers. Trade organizations are typically membership-based organizations comprised of distributors that are not direct competitors. Advantageously, the systems described herein allow multiple different entities as described above to peacefully coexist in a unified ecosystem. The coexistence of these entities is facilitated by a supply chain server that manages supply chain data from the multiple entities, and provides restricted access to that supply chain data on an entity by entity basis. For example, a trusted service provider may manage and operate the supply chain server as described herein.

Referring now to FIG. 9a, an exemplary system 900 for managing and/or presenting supply chain data is depicted. System 900 includes numerous nodes, which may be or include computing nodes 110 as previously described, connected by a network. System 900 may include a supply chain server 901, which may include a database, middleware, and alerting functions. Numerous computing nodes may connect to supply chain server 901, and allow different users having different roles to access supply chain data by connecting to supply chain server 901.

For instance, a distributor, such as a food service distributor, may connect via distributor node 902, a customer may connect via customer node 903, a vendor may connect via vendor node 904, and a trade organization user may connect via trade organization node 905. As may be readily understood, although only one node of each type is depicted in FIG. 9a, system 900 can support numerous users of each type, who may connect from multiple different computing nodes to supply chain server 901.

Advantageously, system 900 can allow both aggregation and separation of supply chain data, and regulate access to that data depending upon the entity seeking access. For example, a specific vendor may be allowed access to sales quantity data (but not price data) of its products to all customers, while a specific distributor may be allowed access to both sales quantity and price data but only for its customers. As another example, a trade organization may be allowed access to sales quantity data and average selling price, but not the individual sales price to any given customer.

FIG. 9b depicts one or more embodiments of a process for managing and/or presenting supply chain data. By way of example, the processes described with respect to FIG. 9b can be performed using one or more programs 140 running on one or more computing node 110, as detailed with respect to FIGS. 1a-1b.

In one embodiment, one or more programs 140 at block 910 presents a distributor user interface having one or more distributor views of the supply chain data to a first user, the one or more distributor views including product information, pricing information, vendor information, and customer information. In one example, the distributor view of the first customer data and the second customer data indicates multiple orders of a common product by different customers.

In another embodiment, one or more programs 140 at block 920 presents a customer user interface having one or more customer views of the supply chain data to a second user, the one or more customer views comprising the product information, the pricing information, and the vendor information. In one example, the customer view of the first distributor data and the second distributor data indicates multiple orders of a common product from different distributors.

In another embodiment, one or more programs 140 at block 930 presents a vendor user interface having one or more vendor views of the supply chain data to a third user, the one or more vendor views comprising the product information and the customer information. In one example, the vendor view of the first distributor data and the second distributor indicates rebate-eligible orders of a product by at least one customer or distributor.

In another embodiment, one or more programs 140 at block 940 presents a trade organization user interface having one or more trade organization views of the supply chain data to a third user, the one or more vendor views including the product information, the pricing information and the distributor information.

FIG. 9c is a diagram illustrating further aspects of a process for managing and/or presenting supply chain data, in accordance with one or more aspects set forth herein. By way of explanation, in FIG. 9c, processes are illustrated from the point of view of a supply chain server one or more program 141 (e.g., running on supply chain server 901 of FIG. 9b), a distributor one or more program 142 (e.g., running on distributor node 902 of FIG. 9b), a customer one or more program 143 (e.g., running on customer node 903 of FIG. 9b), and a vendor one or more program 144 (e.g., running on vendor node 904 of FIG. 9b). For example, one or more program 140 at block 910 (FIG. 9b) presenting a distributor user interface can include one or more program 141-144 performing one or more of blocks 910a-910d. In addition, one or more programs 140 at block 920 (FIG. 9b) presenting a customer user interface can include one or more programs 141-144 performing one or more of blocks 920a-920f. Further, one or more programs 140 at block 930 (FIG. 9b) presenting a vendor user interface can include one or more programs 141-144 performing one or more of blocks 930a-930c.

In one or more embodiments, some or all of the programs 140-144 may run on a different collection of physical or virtual machines or processors, depending on the need for scalability of the system. In another specific example, various portions of supply chain one or more program 141 may run on different processors running on different computing nodes, in order to support a large system with multiple simultaneous users.

FIG. 9c illustrates certain aspects of the present disclosure in which multiple different users having multiple different roles may transact with the supply chain server 901 (see FIG. 9a). In the embodiment of FIG. 9c, the customer one or more programs 143 at block 920a sends login credentials to the supply chain server 901 (FIG. 9a), responsive to user input.

The one or more supply chain server programs 141 at block 920b receives the login credentials and looks up the user's role (i.e., as a customer user) and determines the data permissions affiliated with the user who logged into the system. After validating the user login, the supply chain server one or more program 141 at block 920c performs a database look up and constructs one or more customer views of supply chain data which may include product, vendor and pricing information, and transmits this user interface to the user. By way of explanation, a customer may have relationships with more than one distributor. For example, a first distributor may specialize in a certain type of product, such as produce or fresh meat, while a second distributor may specialize in a different type of product, such as canned goods.

The one or more customer programs 143 at block 920d receives the user interface information from the supply chain server, and presents a customer user interface to the user. The customer user interface may include reporting functions, order entry functions, and other appropriate functions for the specific user who has logged in with a role of customer. As noted above, because the supply chain server allows for a large ecosystem of participants, the customer user interface can provide a single point of contact to multiple different distributors.

The one or more customer programs 143 at block 920e receives the user input and transmits the user input to the supply chain server. For example, the user input may be a customer placing a series of orders with many different distributors. In another example, the user input may be a request for reports of information, such as orders, rebates, and other sales information.

The one or more supply chain programs 141 at block 920f receives the user input and updates the supply chain data base with the user input. Next, one or more transactions may be performed by the supply chain server, such as transacting business with distributors. For example, after receiving a complex order from a customer, the supply chain server may decompose that order into a series of suborders which are then transmitted and recorded so that individual distributors may fulfill appropriate portions of the order. Depending upon the level of automation desired, alerts may be sent so that orders are immediately transmitted for fulfillment.

In another example, the distributor may login to the supply chain server in a manner similar to that described above with respect to the customer. After accepting a login from a distributor user, the one or more supply chain server programs 141 at block 910a performs a database look up to access supply chain data that pertains to the specific distributor user, and for which the specific distributor user is allowed access. For example, after the database lookup, the one or more supply chain server programs 141 constructs one or more distributor views of supply chain data which may include product, pricing, vendor and customer information, and transmits this user interface to the distributor user.

The one or more distributor programs 142 at block 910b receives the user interface information from the supply chain server and presents it to the user. For example, the presented distributor user interface can provide the distributor with an aggregated view of all outstanding customer orders. As another example, the user interface can allow the distributor to prepare bills, reports, and aggregate the supply chain data to perform auditing and other functions. As a further example, the user interface can allow the distributor to mine the supply chain data to find potential upsell opportunities, as described with respect to FIGS. 8a-8d. For example, the distributor can perform a void matrix search that returns a list of customers that are purchasing one product, but not another, related product, and target this list of customers for sales of the related product.

Next, the one or more distributor programs 142 at block 910c accepts and interprets user input to manage the flow of customer orders, scheduling deliveries, etc. The one or more supply chain server programs 141 at block 910d receive the instructions and updates the supply chain database to reflect any transactions with vendors, customers, or other participants. For example, a series of user interface views may be presented to the user so that delivery trucks may be scheduled with appropriate products for different customers.

In another example, a specific vendor user may login to the supply chain server. Then, the one or more supply chain server programs 141 at block 930a can perform a database look up and prepare a vendor user interface having, for example, product and customer information. For example, the database lookup may return only the data records showing purchases of the specific vendor's products (but not the products from other vendors) or may show the different rebate programs that are particular to the specific vendor. The one or more vendor programs 144 at block 930b can present the vendor user interface to the user so that the user may prepare reports. For example, rebate and other incentive programs may then be managed through the one or more vendor programs 144 at block 930c. In such a case, the vendor can prepare rebates for each customer based on their total sales volume of specific vendor products, without having to be cognizant of which distributor the products were received through.

It is to be understood that the exemplary system modules and method steps described herein may be implemented in various forms of hardware, software, firmware, special purpose processors, or a combination thereof. Preferably, the present invention is implemented in software as an application program tangibly embodied on one or more program storage devices. The application program may be executed by any machine, device or platform comprising suitable architecture. It is to be further understood that, because some of the constituent system modules and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate or practice these and similar implementations or configurations of the present invention.

While the invention has been described with reference to specific embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. A system for managing and presenting supply-chain data, the system comprising:
a database for storing the supply-chain data;
a server configured to present multiple role-specific user interfaces to multiple users, the multiple role-specific user interfaces comprising:
a distributor user interface presenting one or more distributor views of the supply chain data to a first user, the one or more distributor views comprising product information, pricing information, vendor information, and customer information;
a customer user interface presenting one or more customer views of the supply chain data to a second user, the one or more customer views comprising the product information, the pricing information, and the vendor information; and
a vendor user interface presenting one or more vendor views of the supply chain data to a third user, the one or more vendor views comprising the product information and the customer information.

2. The system of claim 1, wherein the multiple role-specific user interfaces further comprises a trade organization user interface, the trade organization user interface presenting one or trade organization views of the supply chain data to a fourth user, the one or more trade organization views comprising the product information, the pricing information, and the distributor information.

3. The system of claim 1, wherein the server is further configured to receive the supply-chain data from at least one of the first user, the second user, or the third user.

4. The system of claim 1, wherein the server is further configured to segment the supply-chain data with user-specific permissions, wherein the user-specific permissions facilitate presenting the multiple role-specific user interfaces with different views of the supply-chain data.

5. The system of claim 1, wherein the multiple users comprises a first distributor user and a second distributor user, the supply-chain data comprises first distributor data and second distributor data, and the server is further configured to present a first distributor user interface of the supply-chain data to the first distributor user and a second distributor user interface of the supply-chain data to the second distributor user, wherein the first distributor user interface presents a view of the first distributor data and not the second distributor data and the second distributor user interface presents a view of the second distributor data and not the first distributor data.

6. The system of claim 5, wherein the customer user interface presents a customer view of the first distributor data and the second distributor data.

7. The system of claim 6, wherein the customer view of the first distributor data and the second distributor data indicates multiple orders of a common product from different distributor.

8. The system of claim 5, wherein the vendor user interface presents a vendor view of the first distributor data and the second distributor data.

9. The system of claim 8, wherein the vendor view of the first distributor data and the second distributor indicates rebate-eligible orders of a product by at least one customer.

10. The system of claim 1, wherein the multiple users comprises a first customer user and a second customer user, the supply-chain data comprises first customer data and second customer data, and the server is further configured to present a first customer user interface of the supply-chain data to the first customer user and a second customer user interface of the supply-chain data to the second customer user, wherein the first customer user interface presents a view of the first customer data and not the second customer data and the second customer user interface presents a view of the second customer data and not the first customer data.

11. The system of claim 10, wherein the distributor user interface presents a distributor view of the first customer data and the second customer data.

12. The system of claim 11, wherein the distributor view of the first customer data and the second customer data indicates multiple orders of a common product by different customers.

13. The system of claim 10, wherein the vendor user interface presents a vendor view of the first customer data and the second customer data.

14. The system of claim 10, wherein the vendor view of the first customer data and the second customer data indicates rebate-eligible orders of a product by at least one customer.

15. The system of claim 1, wherein the supply-chain data comprises sales data tables with a vendor name, a distributor name, a customer name, a product name, a product major category, a product minor category, a quantity, a unit price, and an extended price.

16. The system of claim 1, wherein the supply-chain data is foodservice purchase data representing multiple foodservice customers, multiple foodservice vendors, and at least one foodservice distributor, wherein the server is configured for inputting purchases made by the multiple foodservice customers into the database to construct a purchase history for each of the multiple foodservice customers.

17. A method for managing and presenting supply-chain data, the method comprising the steps of:
storing the supply-chain data in a database;
presenting multiple role-specific user interfaces to multiple users, the presenting comprising:
presenting a distributor user interface having one or more distributor views of the supply chain data to a first user, the one or more distributor views comprising product information, pricing information, vendor information, and customer information;
presenting a customer user interface having one or more customer views of the supply chain data to a second user, the one or more customer views comprising the product information, the pricing information, and the vendor information; and
presenting a vendor user interface having one or more vendor views of the supply chain data to a third user, the one or more vendor views comprising the product information and the customer information.

18. A computer program product comprising a program storage hardware readable by machine, tangibly embodying a program of instructions executable by machine to perform method steps for managing and presenting supply-chain data, the method comprising the steps of:
storing the supply-chain data in a database;
presenting multiple role-specific user interfaces to multiple users, the presenting comprising:
presenting a distributor user interface having one or more distributor views of the supply chain data to a first user, the one or more distributor views comprising product information, pricing information, vendor information, and customer information;
presenting a customer user interface having one or more customer views of the supply chain data to a second user, the one or more customer views comprising the product information, the pricing information, and the vendor information; and
presenting a vendor user interface having one or more vendor views of the supply chain data to a third user, the one or more vendor views comprising the product information and the customer information.
